(19) United States
(12) Patent Application Publication
(10) Pub. No.: US 2024/0263292 A1
(43) Pub. Date: Aug. 8, 2024

(54) HIGH-PERFORMANCE COMPOSITE COATING AND PREPARATION METHOD AND USE THEREOF

(71) Applicant: Army Academy of Armored Forces of PLA, Beijing (CN)

(72) Inventors: Weiling GUO, Beijing (CN); Haidou WANG, Beijing (CN); Zhiguo XING, Beijing (CN); Guozheng MA, Beijing (CN); Ming LIU, Beijing (CN); Lihong DONG, Beijing (CN); Peng LI, Beijing (CN)

(73) Assignee: Army Academy of Armored Forces of PLA, Beijing (CN)

(21) Appl. No.: 18/137,019

(22) Filed: Apr. 20, 2023

(30) Foreign Application Priority Data
Feb. 7, 2023 (CN) 2023101339093

(51) Int. Cl. C23C 4/10; C23C 4/06

(52) U.S. Cl. CPC C23C 4/10; C23C 4/06

(57) ABSTRACT

Provided are a high-performance composite coating and a preparation method and use thereof, which relates to the field of composite coating materials. The method includes steps: (1) ball milling a Cu powder, a Ti₃AlC₂ powder, an organic adhesive, a dispersant, and water to obtain a mixed slurry; (2) subjecting the mixed slurry obtained in step (1) to spray granulation to obtain granules, and sintering the granules to obtain a composite powder; and (3) spraying the composite powder obtained in step (2) onto a substrate material to obtain the high-performance composite coating.

### CROSS REFERENCE TO RELATED APPLICATION

This patent application claims the benefit and priority of Chinese Patent Application No. 2023101339093 filed with the China National Intellectual Property Administration on Feb. 7, 2023, the disclosure of which is incorporated by reference herein in its entirety as part of the present application.

### TECHNICAL FIELD

The present disclosure relates to the field of composite coating materials, in particular to a high-performance composite coating and a preparation method and use thereof.

### BACKGROUND

In recent years, with the rapid development of manufacturing technology for advanced sophisticated equipment, automation equipment, and aerospace equipment and other national defense and military equipment, there is an increasing demand of conductive slip rings for precision equipment. Due to long-term operations in a harsh natural environment, such as high voltage, high current, high speed, and high load, the conductive slip rings for precision equipment are prone to mechanical wear, arc ablation, chemical wear and other damages. This greatly reduces the reliability and service life of the slip ring. Moreover, with the rapid development of science and technology and the rapid progress of industry, the conductive slip rings for precision equipment have greatly increased power transmission density, and increasing relative motion speed and load. This imposes higher requirements on the surface coating of precision and conductive slip rings.

Therefore, it has become an urgent technical problem to be solved in this field to provide a high-performance composite coating with desirable mechanical properties and excellent conductivity and wear resistance, such that the precision and conductive slip rings could be used for a long time under severe working conditions.

### SUMMARY

An object of the present disclosure is to provide a high-performance composite coating and a preparation method and use thereof. The high-performance composite coating has desirable mechanical properties, conductivity, and wear resistance, which meets high-performance requirements of a surface coating for a precision and conductive slip ring.

To achieve the above object, the present disclosure provides the following technical solutions:

The present disclosure provides a method for preparing a high-performance composite coating, including the following steps:

(1) ball milling a Cu powder, a Ti₃AlC₂ powder, an organic adhesive, a dispersant, and water to obtain a mixed slurry;

(2) subjecting the mixed slurry obtained in step (1) to spray granulation to obtain granules, and sintering the granules to obtain a composite powder, and

(3) spraying the composite powder obtained in step (2) onto a substrate material to obtain the high-performance composite coating.

In some embodiments, in step (1), a volume ratio of the Cu powder to the Ti₃AlC₂ powder is in a range of (55-65):(35-45).

In some embodiments, in step (1), the Cu powder and the Ti₃AlC₂ powder each independently have a particle size of 2 μm to 8 μm.

In some embodiments, in step (1), the organic adhesive is in an amount of 1% to 3% of a total mass of the Cu powder and the Ti₃AlC₂ powder.

In some embodiments, in step (1), the dispersant is in an amount of 0.2% to 0.8% of a total mass of the Cu powder and the Ti₃AlC₂ powder.

In some embodiments, in step (2), the sintering is conducted at a temperature of 500° C. to 950° C. for 1 h to 4 h.

In some embodiments, in step (2), the composite powder has a particle size of 15 μm to 45 μm.

In some embodiments, in step (3), the spraying is conducted at a temperature of 600° C. to 800° C. and a pressure of 5 MPa to 6 MPa.

The present disclosure further provides a high-performance composite coating prepared by the method as described above.

The present disclosure further provides use of the high-performance composite coating as described above in a conductive slip ring for precision equipment.

The present disclosure provides a method for preparing a high-performance composite coating, including the following steps: (1) ball milling a Cu powder, a Ti₃AlC₂ powder, an organic adhesive, a dispersant, and water to obtain a mixed slurry; (2) subjecting the mixed slurry obtained in step (1) to spray granulation to obtain granules, and sintering the granules to obtain a composite powder; and (3) spraying the composite powder obtained in step (2) onto a substrate material to obtain the high-performance composite coating. In the present disclosure, a spherical Cu—Ti₃AlC₂ composite powder is prepared by spray granulation, and the Cu—Ti₃AlC₂ composite powder is shaped by sintering to improve flowability of the composite powder, which is beneficial to subsequent spraying uniformity of the composite powder. By compounding the Cu powder with the Ti₃AlC₂ powder and adopting a spraying process, less collision and rebound of ceramic particles occurs between individual agglomerated powders, and the ceramic particles inside the powder are prone to particle collision and fragmentation, thereby forming a metal-ceramic composite deposition coating with a higher ceramic content. The ceramic particles in the powder violently collides and breaks, and then are bonded by Cu particles in an agglomerated structure. The subsequently deposited particles hit the surface at a high speed to further hammer and tamp the previously deposited particles, so as to achieve a compact bonding effect among particles, and improve a bonding force and wear resistance of the coating; meanwhile, the conductivity of the coating is improved due to the presence of metal Cu. The experimental results show that the high-performance composite coating prepared by the method for preparing the high-performance composite coating according to the present disclosure has a hardness of 231.5 HV to 397.1 HV and a bonding strength of 10 MPa to 50 MPa. Under dry grinding conditions, the coating has a friction coefficient of 0.506 to 0.606, a volume wear of 10.6×10⁴ mm³ to 22.8×10³ mm³, and a wear scar depth of 10.17 μm to 15.14 μm. Under 2 A current-carrying friction conditions, the coating has a friction coefficient of 0.487 to 0.548, a volume wear of 6.9×10³ mm³ to 13.7×10³ mm³, and a wear scar depth of 6.59 μm to 11.64 μm. Therefore, the coating has desirable mechanical properties, conductivity, and wear resistance.

### BRIEF DESCRIPTION OF THE DRAWINGS

FIG. 1 shows a scanning electron microscopy (SEM) image of a raw material Cu powder used in an embodiment of the present disclosure.

FIG. 2 shows an SEM image of a raw material Ti₃AlC₂ powder used in an embodiment of the present disclosure.

FIG. 3 shows an SEM image of a composite powder prepared in Example 1 of the present disclosure.

FIG. 4 shows a particle size distribution diagram of the composite powder prepared in Example 1 of the present disclosure.

FIG. 5 shows an SEM image of the cross-section of the composite powder prepared in Example 1 of the present disclosure.

FIG. 6 shows parameters of a blasted surface of the substrate material in Example 1 of the present disclosure.

FIG. 7 shows a schematic diagram of deposition process of individual composite powder according to an embodiment of the present disclosure.

FIG. 8 and FIG. 9 show SEM images of surfaces of the composite powder deposited on a substrate in Example 2 of the present disclosure.

FIG. 10 and FIG. 11 show SEM images of surfaces of the composite powder deposited on a substrate in Example 3 of the present disclosure.

FIG. 12 shows an SEM image of the cross-section of the composite powder deposited on the substrate in Example 2 of the present disclosure.

FIG. 13 shows an SEM image of the cross-section of the composite powder deposited on the substrate in Example 3 of the present disclosure.

FIG. 14A shows an SEM image of a polished surface of the high-performance composite coating of Example 1 of the present disclosure; FIG. 14B shows the corresponding energy dispersive spectroscopy spectrum.

FIG. 15A shows an SEM image of a polished surface of the high-performance composite coating of Example 2 of the present disclosure; FIG. 15B shows the corresponding energy dispersive spectroscopy spectrum.

FIG. 16A shows an SEM image of a polished surface of the high-performance composite coating of Example 3 of the present disclosure; FIG. 16B shows the corresponding energy dispersive spectroscopy spectrum.

FIG. 17 shows an SEM image of a polished cross-section of a bonding interface of the high-performance composite coating and the substrate in Example 1 of the present disclosure.

FIG. 18 shows an SEM image of a polished cross-section of a bonding interface of the high-performance composite coating and the substrate in Example 2 of the present disclosure.

FIG. 19 shows an SEM image of a polished cross-section of a bonding interface of the high-performance composite coating and the substrate in Example 3 of the present disclosure.

FIG. 20 shows an energy dispersive spectroscopy (EDS) spectrum of the polished cross-section of the bonding interface of the high-performance composite coating and the substrate in Example 1 of the present disclosure.

FIG. 21 shows an EDS spectrum of the polished cross-section of the bonding interface of the high-performance composite coating and the substrate in Example 2 of the present disclosure.

FIG. 22 shows an EDS spectrum of the polished cross-section of the bonding interface of the high-performance composite coating and the substrate in Example 3 of the present disclosure.

FIG. 23 shows X-ray diffraction (XRD) patterns of the high-performance composite coatings of Examples 1 to 3 in the present disclosure.

FIG. 24 and FIG. 25 show SEM images of the fracture surfaces on the substrate side of the high-performance composite coating prepared in Example 2.

FIG. 26 and FIG. 27 show SEM images of the fracture surface on the substrate side of the high-performance composite coating prepared in Example 3.

FIG. 28 and FIG. 29 show SEM images of the fracture surface on the coating side of the high-performance composite coating prepared in Example 2.

FIG. 30 and FIG. 31 show SEM images of the fracture surface on the coating side of the high-performance composite coating prepared in Example 3.

FIG. 32 shows a variation curve of friction coefficient of the high-performance composite coatings prepared in Examples 1 to 3 versus time.

FIG. 33 shows a histogram of the friction coefficient and volume wear corresponding to the high-performance composite coatings prepared in Examples 1 to 3.

FIG. 34 shows a two-dimensional profile of wear scars of the high-performance composite coatings prepared in Examples 1 to 3 under a dry friction test.

FIG. 35 shows an SEM image of wear scars of the high-performance composite coating prepared in Example 1.

FIG. 36 shows an SEM image of wear scars of the high-performance composite coating prepared in Example 2.

FIG. 37 shows an SEM image of wear scars of the high-performance composite coating prepared in Example 3.

FIG. 38 shows a variation curve of the friction coefficient of the high-performance composite coatings prepared in Examples 1 to 3 versus time under 2 A current-carrying conditions.

FIG. 39 shows a histogram of the friction coefficient and the volume wear corresponding to the high-performance composite coatings prepared in Examples 1 to 3 in a 2A current-carrying friction experiment.

FIG. 40 shows a two-dimensional profile of the wear scars of the high-performance composite coatings prepared in Examples 1 to 3 under 2 A current-carrying friction.

FIG. 41 shows an SEM image of the wear scars of the high-performance composite coating prepared in Example 1 under the 2 A current-carrying friction.

FIG. 42 shows an SEM image of the wear scars of the high-performance composite coating prepared in Example 2 under the 2 A current-carrying friction.

FIG. 43 shows an SEM image of the wear scars of the high-performance composite coating prepared in Example 3 under the 2 A current-carrying friction.

FIG. 44 shows an SEM image of the wear scars of the high-performance composite coating prepared in Example 3 under the 2 A current-carrying friction.

### DETAILED DESCRIPTION OF THE EMBODIMENTS

The present disclosure provides a method for preparing a high-performance composite coating, including the following steps:

(1) ball milling a Cu powder, a Ti₃AlC₂ powder, an organic adhesive, a dispersant, and water to obtain a mixed slurry;

(2) subjecting the mixed slurry obtained in step (1) to spray granulation to obtain granules, and sintering the granules, to obtain a composite powder; and

(3) spraying the composite powder obtained in step (2) onto a substrate material to obtain the high-performance composite coating.

In the present disclosure, a Cu powder, a Ti₃AlC₂ powder, an organic adhesive, a dispersant, and water are ball milled to obtain a mixed slurry.

In some embodiments of the present disclosure, a volume ratio of the Cu powder to the Ti₃AlC₂ powder is in a range of (55-65):(35-45), preferably (58-62):(38-42), and even more preferably 60:40. By limiting the volume ratio of the Cu powder to the Ti₃AlC₂ powder within the above range, the flowability of the composite powder can be improved, and the bonding strength to the substrate, wear resistance, and conductivity of the composite powder can also be improved.

In some embodiments of the present disclosure, the Cu powder and the Ti₃AlC₂ powder each independently have a particle size of 2 μm to 8 μm, and preferably 3 μm to 5 μm. By limiting the particle size of the Cu powder and the Ti₃AlC₂ powder within the above range, the difficulty of granulation can be reduced, and the bonding strength, conductivity, and wear resistance of the coating can be improved.

In some embodiments of the present disclosure, the organic adhesive is in an amount of 1% to 3%, preferably 2% of a total mass of the Cu powder and the Ti₃AlC₂ powder. The addition amount of the organic adhesive is limited within the above range, such that the Cu powder and the Ti₃AlC₂ powder can be better compounded together through ball milling and rolling.

In some embodiments of the present disclosure, the organic adhesive is one or more selected from the group consisting of asphalt, resin, rubber, gum arabic, and polyvinyl alcohol. When the organic adhesive is limited to the above types, they can bind other materials into a whole, and confer to a certain strength.

In some embodiments of the present disclosure, the dispersant is in an amount of 0.2% to 0.8%, preferably 0.5% of a total mass of the Cu powder and the Ti₃AlC₂ powder. There is no special limitation on the type of the dispersant, and conventional dispersants in the field can be used as needed. By limiting the addition amount of the dispersant within the above range, the slurry material can be distributed more uniformly, resulting in increased suspension performance, which prevents excessive precipitation caused by heavy copper powder.

In some embodiments of the present disclosure, a ratio of the mass of grinding balls used during the ball milling to a total mass of the Cu powder and the Ti₃AlC₂ powder is 2:1. There is no special limitation on what are the grinding balls made of, and a conventional selection can be made as required. By limiting the mass of the grinding balls within the above range, the ball milling can be performed more fully to improve the mixing uniformity of the materials.

In some embodiments of the present disclosure, the ball milling is conducted for 8 h to 12 h, more preferably 10 h. In some embodiments, the ball milling is conducted at a rotational speed of 12 Hz to 16 Hz, and preferably 13 Hz to 15 Hz. By setting the time and rotational speed for the ball milling within the above ranges, the material can be mixed more uniformly.

In the present disclosure, the mixed slurry is subjected to spray granulation, obtaining granules, and the granules are sintered, to obtain a composite powder.

In some embodiments of the present disclosure, the spray granulation is conducted in a GL-5 centrifugal spray dryer. In some embodiments, an inlet temperature of a spray dryer is 250° C. to 260° C. and an outlet temperature of a spray dryer is 115° C. to 120° C. In the present disclosure, the inlet and outlet temperatures of the spray dryer are limited within the above range, so that it can ensure sufficient temperature is provided to dry the slurry instantly during the production.

In some embodiments of the present disclosure, the spray dryer has a spray disc at a rotational speed of 180 Hz to 320 Hz. By setting the rotational speed of the spray disc within the above range, a composite powder with better flowability can be obtained.

In some embodiments of the present disclosure, after the spray granulation is finished, the obtained granules are sieved and then sintered. There are no special limitations on a sieving operation, as long as the particle size can be controlled to be 20 μm to 70 μm.

In some embodiments of the present disclosure, the sintering is conducted at a temperature of 500° C. to 950° C., and preferably 900° C. In some embodiments, the sintering is conducted for 1 h to 4 h, and preferably 2 h. By setting the temperature and time for the sintering within the above ranges, the organic adhesive in the composite powder can be fully decomposed, a required particle size yield is ensured, and the flowability of the powder is improved.

In some embodiments of the present disclosure, the sintering is conducted in a protective atmosphere. There is no special limitation on the protective atmosphere for the sintering, as long as it can guarantee that the composite powder has an oxygen content of 3.4% to 3.5%. By using a protective atmosphere during the sintering, the entry of oxygen can be reduced, thereby avoiding the oxidation of the composite powder.

In some embodiments of the present disclosure, after the sintering is finished, the sintered granules is air-cooled to room temperature and then sieved, to obtain a composite powder. By lowering temperature by air cooling, it can ensure that the cooling rate is not too large, thereby avoiding reducing the quality of the powder.

In some embodiments of the present disclosure, the composite powder has a particle size of 15 μm to 45 μm, preferably 20 μm to 40 μm. By setting the particle size of the composite powder within the above range, it can be more conducive to subsequent spraying.

In the present disclosure, the composite powder is sprayed onto a substrate material to obtain the high-performance composite coating.

In some embodiments of the present disclosure, the substrate material is brass H65.

In some embodiments of the present disclosure, the composite powder and the substrate material are pretreated separately before spraying.

In some embodiments of the present disclosure, pretreating the composite powder is conducted by drying the composite powder.

In some embodiments of the present disclosure, the drying is conducted at 70° C. In some embodiments, the drying is conducted for 30 min. By setting the parameters for drying within the above range, it can prevent the powder from being dampened, which otherwise adversely affects the spray fluidity.

In some embodiments of the present disclosure, pretreatmenting the substrate material includes sequentially conducting an ultrasonic cleaning, a sandblasting, and a second ultrasonic cleaning on the substrate material.

In some embodiments of the present disclosure, a solvent for the ultrasonic cleaning is absolute ethanol. In some embodiments, the ultrasonic cleaning is conducted for 10 min to 20 min. In some embodiments, the ultrasonic cleaning is conducted with an ultrasonic frequency of 20 K-Iz to 1,000 KHz. The ultrasonic cleaning of the substrate material can remove grease, rust and other dirt on a surface of a substrate.

In some embodiments of the present disclosure, the sandblasting is conducted in a press-in type sandblasting device. In some embodiments, sand particles used for the sandblasting are brown fused alumina with a particle size of 500 μm to 700 μm. In some embodiments, the sandblasting is conducted at a sandblasting angle of 70° to 80°. In some embodiments, the sandblasting is conducted at a distance of 180 mm to 240 mm. In some embodiments, the sandblasting is conducted at a pressure of 0.7 MPa. There is no special requirement for a sandblasting time, as long as a surface roughness Sq of 12.5 μm to 13.0 μm and a surface Sa of 7.8 μm to 7.9 μm can be achieved for the substrate material. By setting the parameters for the sandblasting within the above ranges, a rough surface can be formed on the copper substrate material, increasing a mechanical interlocking force between the sprayed particles and the surface of the substrate, thereby improve a bonding strength of the coating.

In some embodiments of the present disclosure, a solvent for the second ultrasonic cleaning is absolute ethanol. In some embodiments, the second ultrasonic cleaning is conducted for 10 min to 20 min. In some embodiments, the second ultrasonic cleaning is conducted with an ultrasonic frequency of 20 KHz to 1,000 KHz. By subjecting the substrate material after sandblasting to a second ultrasonic cleaning, a clean and rough surface can be obtained, thereby improving the bonding strength of the coating.

In some embodiments of the present disclosure, the spraying is conducted in a PCS-1000 cold spraying equipment, and the PCS-1000 cold spray equipment is provided by Beijing United Coating Co., Ltd, China.

In some embodiments of the present disclosure, the spraying is conducted at a temperature of 600° C. to 800° C., and preferably 700° C. to 800° C. In some embodiments, the spraying is conducted at a pressure of 5 MPa to 6 MPa, and preferably 5 MPa to 5.5 MPa. By setting the spraying temperature and pressure within the above range, the bonding strength and deposition efficiency of the coating can be improved, thereby improving the conductivity and wear resistance of the coating.

In some embodiments of the present disclosure, a distance between an outlet of a spray gun and the coating is 10 mm to 20 mm during the spraying. In some embodiments, a powder feeding rate during the spraying is 4 r/s to 8 r/s. In some embodiments, the spray gun is reciprocated for 6 to 10 times. In some embodiments, the spray gun is at a rate of 800 mm/s to 1,000 mm/s. In some embodiments, a spraying angle relative to the substrate material is 90°. By setting the parameters during the spraying within the above range, the bonding strength, conductivity, and wear resistance of the coating can be further improved.

In some embodiments of the present disclosure, the high-performance composite coating has a thickness of 700 μm to 800 μm. By limiting the thickness of the high-performance composite coating within the above range, the bonding strength, conductivity, and wear resistance of the coating can be improved.

In the present disclosure, by compounding the Cu powder with the Ti₃AlC₂ powder and adopting the spraying, during the powder deposition, less collision and rebound of ceramic particles occur between individual agglomerated powders, and the ceramic particles inside the powder are prone to particle collision and fragmentation, thereby forming a metal-ceramic composite deposition coating with a higher ceramic content. The ceramic particles in the powder violently collide and breaks, and then are bonded by Cu particles in a agglomerated structure. The subsequently deposited particles hit the surface at a high speed to further hammer and tamp the previously deposited particles, so as to achieve an effect of inter-particle bonding and compactness, and improve a bonding force and wear resistance of the coating. Meanwhile, the conductivity of the coating is improved due to the presence of metal Cu.

The present disclosure further provides a high-performance composite coating prepared by the method as described in the above technical solutions.

In the present disclosure, a Cu—Ti₃AlC₂ composite powder is cold-sprayed onto a surface of the substrate material to obtain a high-performance composite coating with desirable mechanical properties, conductivity, and wear resistance.

The present disclosure provides use of the high-performance composite coating as described in the above technical solutions in a conductive slip ring for precision equipment.

The technical solutions of the present disclosure will be clearly and completely described below with reference to the examples of the present disclosure. Apparently, the described examples are only a part of, not all of, the examples of the present disclosure. All other examples obtained by a person of ordinary skill in the art based on the examples of the present disclosure without creative labor shall fall within the protection scope of the present disclosure.

### Example 1

A high-performance composite coating was prepared according to the following procedures.

(1) A Cu powder with a particle size of 3 μm, a Ti₃AlC₂ powder with a particle size of 5 μm, gum arabic, a dispersant, and water were ball milled, obtaining a mixed slurry, wherein a volume ratio of the Cu powder to the Ti₃AlC₂ powder was 60:40; the amount of the gum arabic (as the organic adhesive) was 2% of a total mass of the Cu powder and the Ti₃AlC₂ powder; and the amount of the dispersant was 0.5% of a total mass of the Cu powder and the Ti₃AlC₂ powder.

(2) In a GL-5 centrifugal spray dryer (with a spray disc at a rotational speed of 250 Hz), the mixed slurry obtained in step (1) was subjected to spray granulation (the inlet temperature of the spray dryer being 250° C., the outlet temperature of the spray dryer being 120° C.), obtaining granules. The granules were sieved to arrive at a particle size of 20 μm to 70 μm. The obtained granules by sieving was sintered at 900° C. for 2 h, obtaining sintered granules. The sintered granules were air-cooled to room temperature, and then sieved, obtaining a composite powder with a particle size of 15 μm to 45 μm, an oxygen content in the composite powder being 3.41%.

(3) The composite powder obtained in step (2) was dried at 70° C. for 30 min, obtaining a pretreated composite powder. Brass H65 was sonicated in absolute ethanol at 28 KHz for 15 min, obtaining a sonicated brass H65. The sonicated brass H65 was put into a press-in type sandblasting device, and then subjected to a sandblasting by using brown fused alumina with a sand particle size of 500 μm to 700 μm, at a sandblasting angle of 75°, a sandblasting distance of 200 mm, and a sandblasting pressure of 0.7 MPa, obtaining a pretreated substrate with surface roughness Sq of 12.8 μm and Sa of 7.81 μm. The pretreated composite powder was sprayed onto the pretreated brass H65 (the spraying being conducted at 600° C. and 5 MPa; during the spraying, a distance between a spray gun outlet and the coating being 10 mm, and a powder feeding rate being 4 r/s; the spray gun being at a rate of 800 mm/s and reciprocating for 6 times; a spraying angle relative to the substrate material being 90°), obtaining the high-performance composite coating.

The performances of the high-performance composite coating prepared in this example are shown in Table 4.

### Example 2

This example was performed according to the procedures as described in Example 1, except that the spraying was conducted at 700° C.

The performances of the high-performance composite coating prepared in this example are shown in Table 4.

### Example 3

This example was performed according to the procedures as described in Example 1, except that the spraying was conducted at 800° C.

The performances of the high-performance composite coating prepared in this example are shown in Table 4.

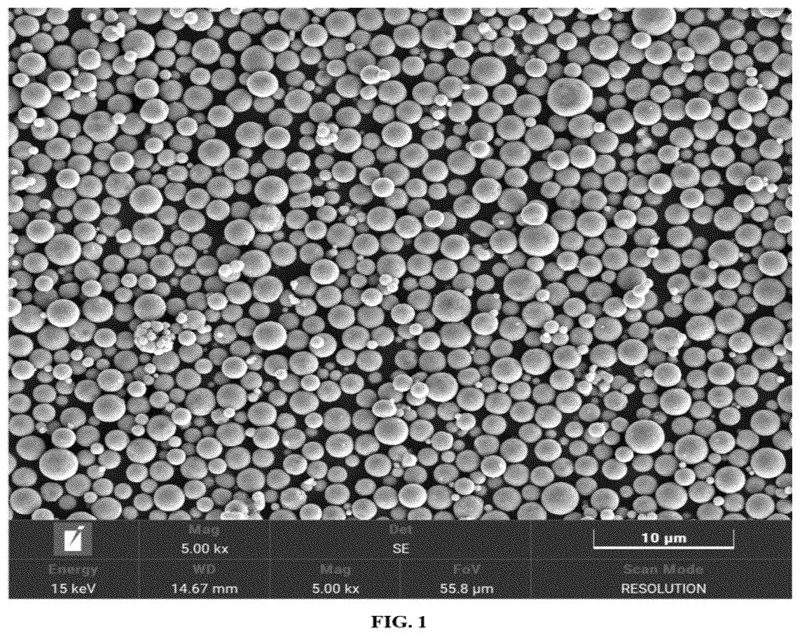

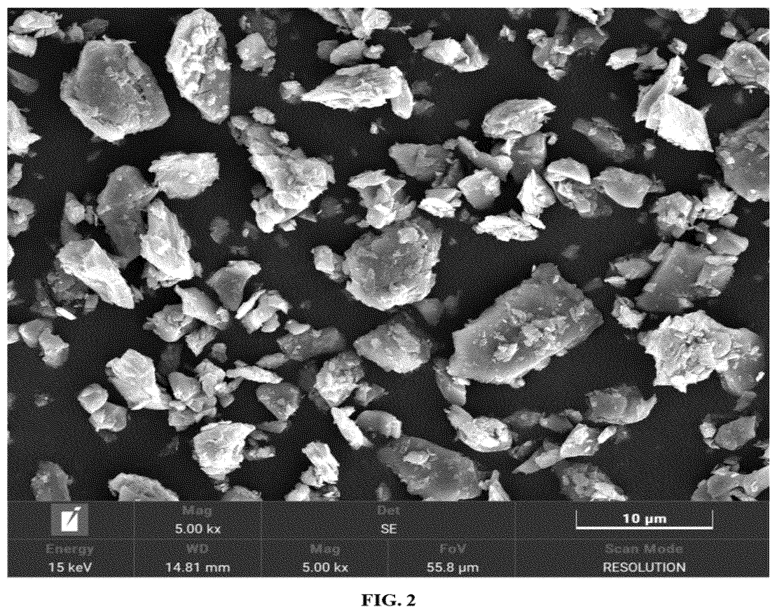

As can be seen from the SEM image in FIG. 1, the Cu powder used in the present disclosure is in a uniform spherical shape and thus has desirable flowability.

As can be seen from the SEM image of FIG. 2, the Ti₃AlC₂ powder used in the present disclosure is in an irregular lamellar shape.

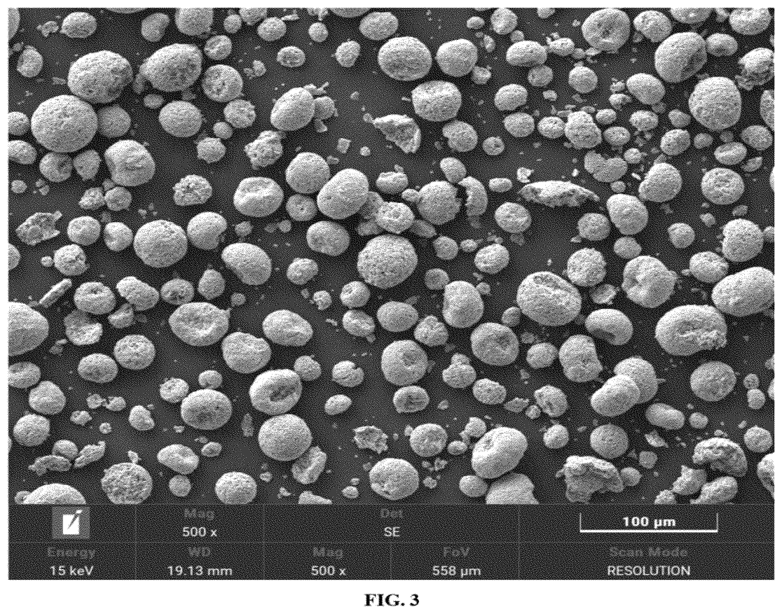

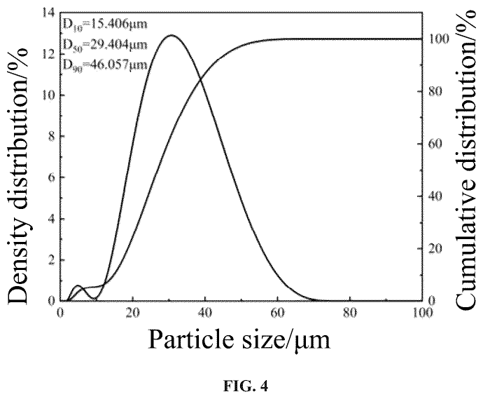

As can be seen from FIG. 3 and FIG. 4, the composite powder according to the present disclosure has a particle size distribution of 15 μm to 45 μm.

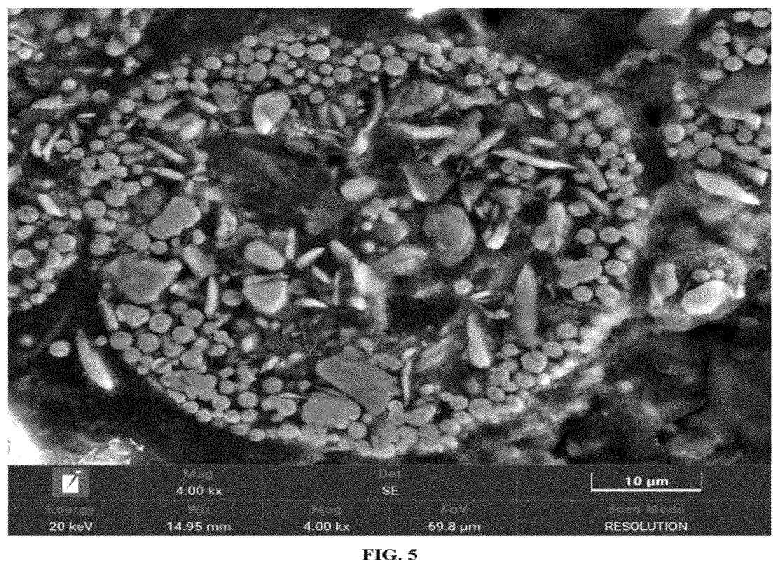

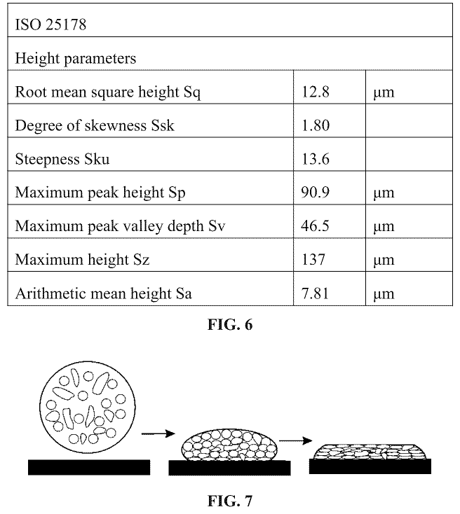

As can be seen from the SEM image of FIG. 5, the composite powder according to the present disclosure has desirable sphericity and relatively uniform components distribution. Irregular lamellar Ti₃AlC₂ powder is clearly visible in the agglomerated powder, most of the copper particles are distributed on the outside, wrapping the ceramic particles therein, and there are many ceramic particles in the inner but the hollow still exists sometimes. Therefore, during the spraying and powder deposition, less collision and rebound of ceramic particles occur between individual agglomerated powders, and the ceramic particles inside the powder are prone to particle collision and fragmentation, thereby forming a metal-ceramic composite deposition coating with a higher ceramic content.

As can be seen from FIG. 6 and a three-dimensional profile of a surface of a substrate material after sandblasting in Example 1 of the present disclosure, after sandblasting the substrate material of the present disclosure, the surface of the substrate have desirable roughness.

As can be seen from FIG. 7, during the deposition of the composite powder, the peripheral bottom of the spherical agglomerated composite powder firstly contacts the surface of the substrate and impact to form a sedimentary body, and the internal particles hammer and tamp the sedimentary body of the bottom. When all the particles inside the agglomerated form are impinged by the airflow of the spray gun and deposited, the individual agglomerated composite powder forms a ladder-like flat deposit. Due to the deposition of the composite powder with a high ceramic content, severe plastic deformation is caused between particles in the agglomerated composite powder, easily leading to impact and fracture of ceramics with high rigidity and brittleness. Moreover, there is a certain Van der Waals force among the spherical agglomerated composite particles, and thus they are not easy to disperse during the spray deposition, such that the agglomerated powder is deposited onto a surface of the mirror substrate in an intact powder form.

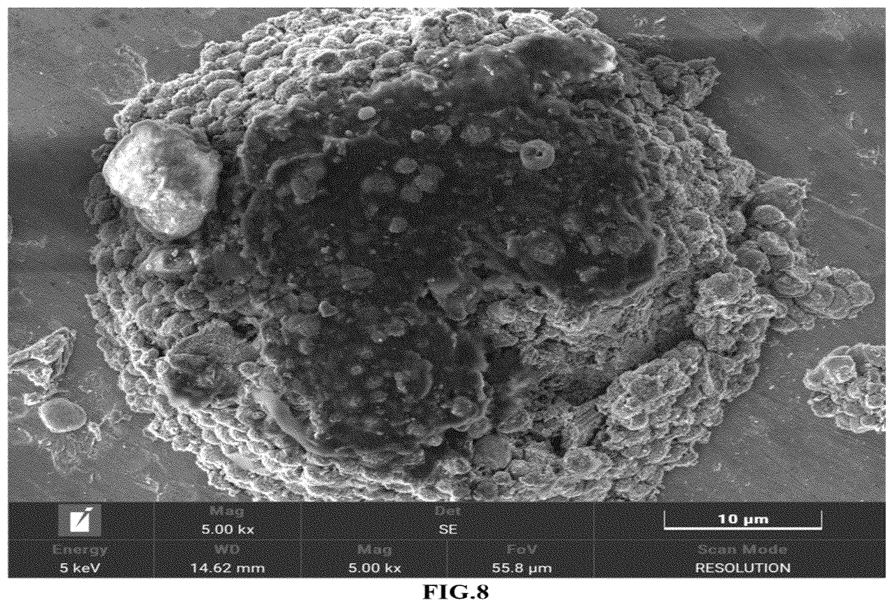

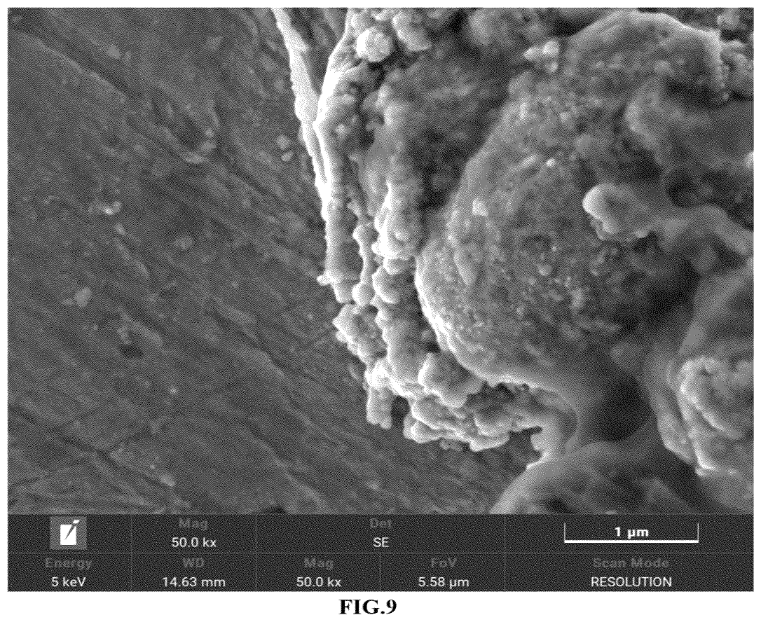

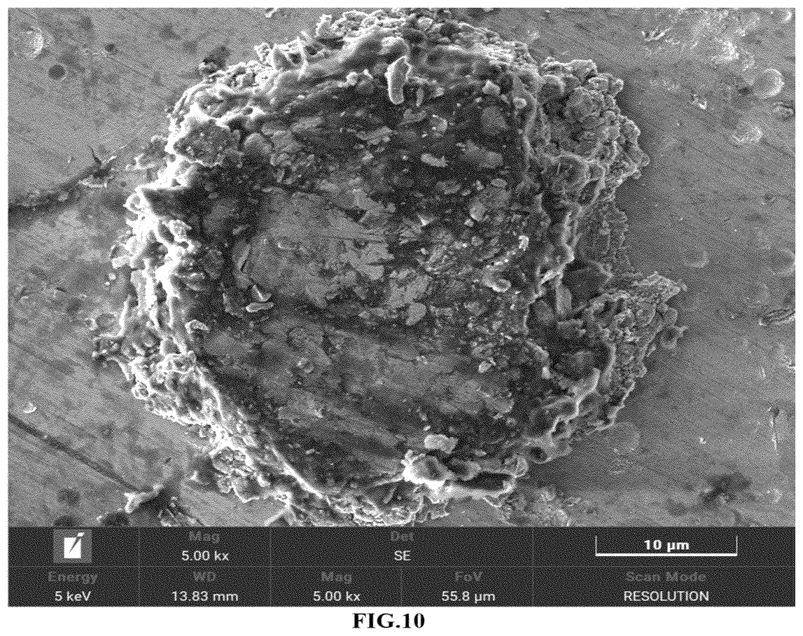

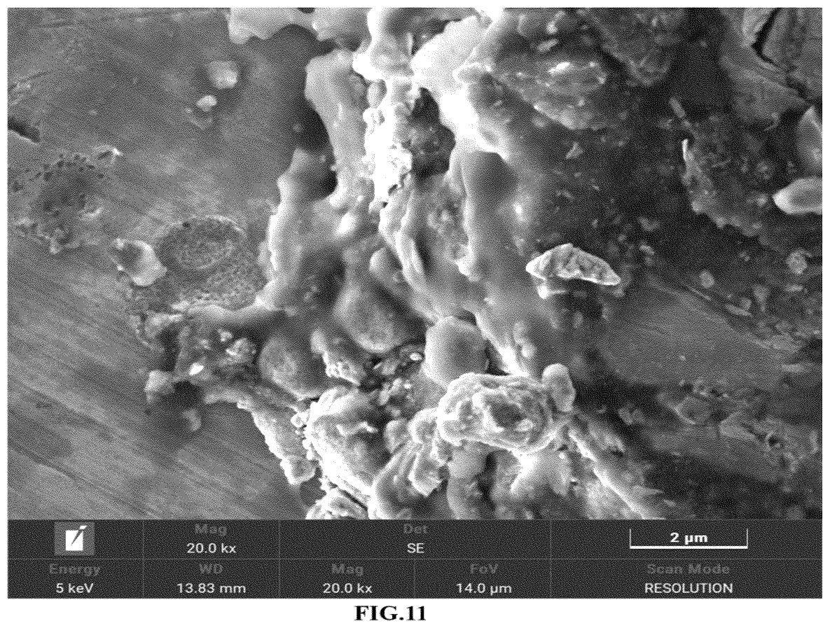

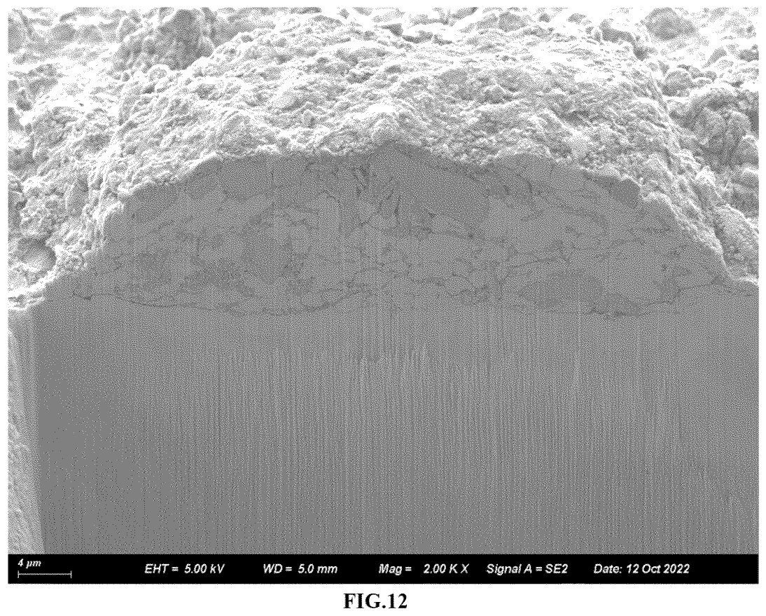

As can be seen from FIG. 8 to FIG. 11, after the impact and deposition of the agglomerated composite powder, the obtained sedimentary body is in the shape of a truncated cone, and there is no obvious metal jet phenomenon. Meanwhile, a sedimentary body with a higher ceramic content appears at the top; however, the tops of the surface layers of these sedimentary bodies are relatively flat compared with those of sedimentary bodies with less ceramic. This is due to the fact that it is hollow inside the agglomerated powder, and the internal pores are filled and consolidated by copper particles during the deposition, such that the surface of the sedimentary body is flattened under the impact force. From FIG. 9 and FIG. 11, it is clearly seen that a melting part appears at the edge of the sedimentary body at a higher temperature, and the temperature at the edge of the sedimentary body is higher due to the concentration of stress and strain at the edge.

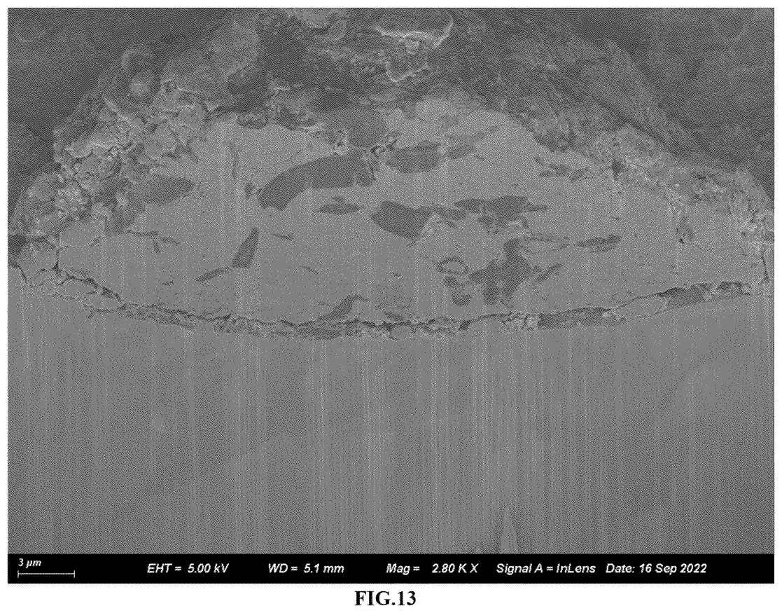

As can be seen from FIG. 12 and FIG. 13, there is no obvious metal jet phenomenon after the deposition of individual agglomerated particle, so the agglomerated powder could effectively limit the generation of metal jets. However, there are some defects and poor interface bonding among the particles. Since the ceramic particles play a tamp role in the sedimentary body, the ceramic hammers the copper, such that the bonding of the copper is denser. Therefore, there is a relatively obvious boundary at the junction between the sedimentary body and the substrate surface, resulting in that the bonding strength at the bonding interface between the coating and the substrate is lower than a cohesive strength between particles.

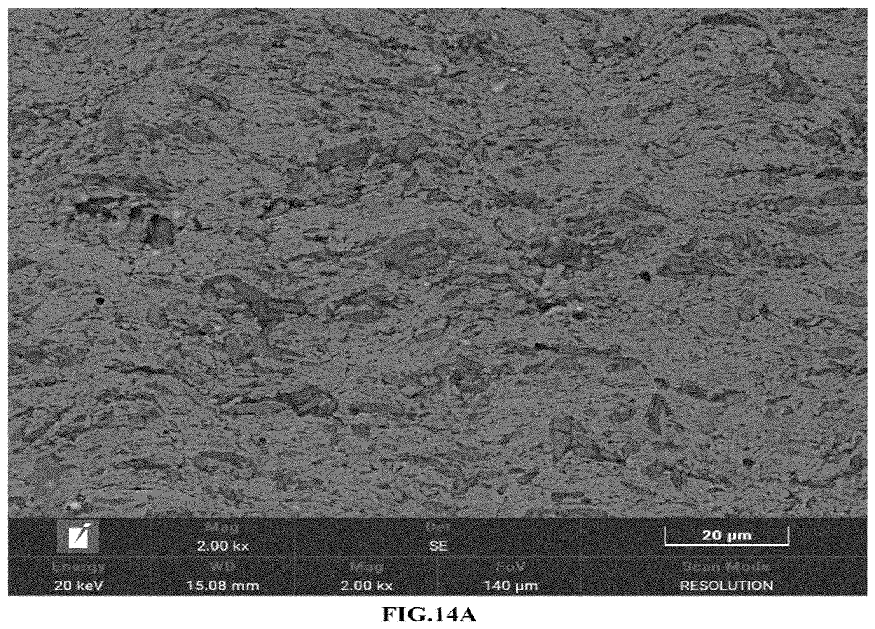

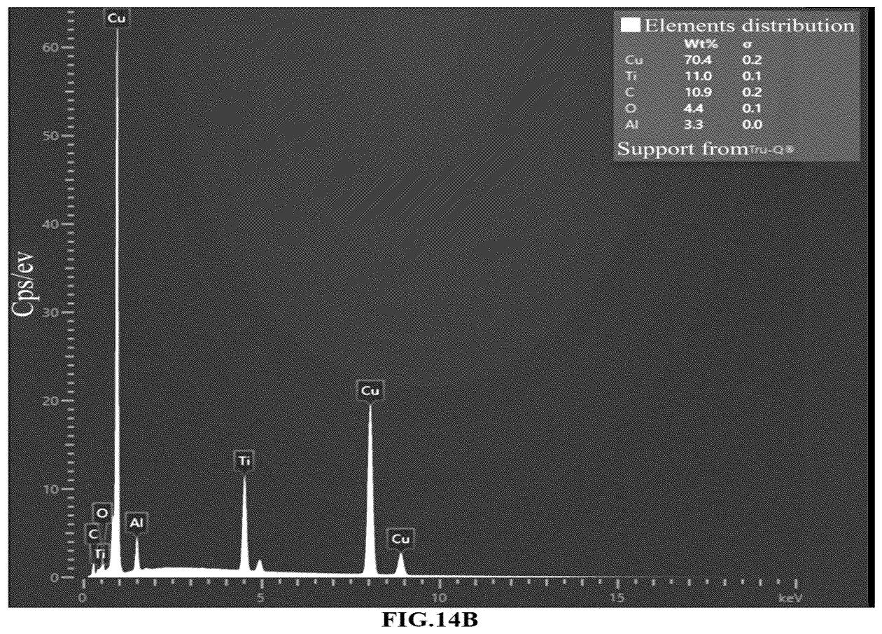

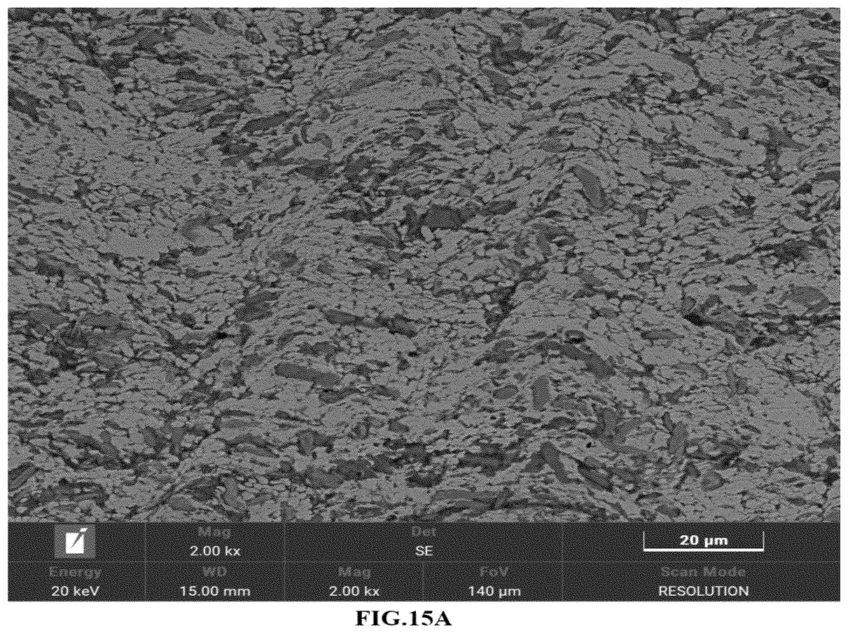

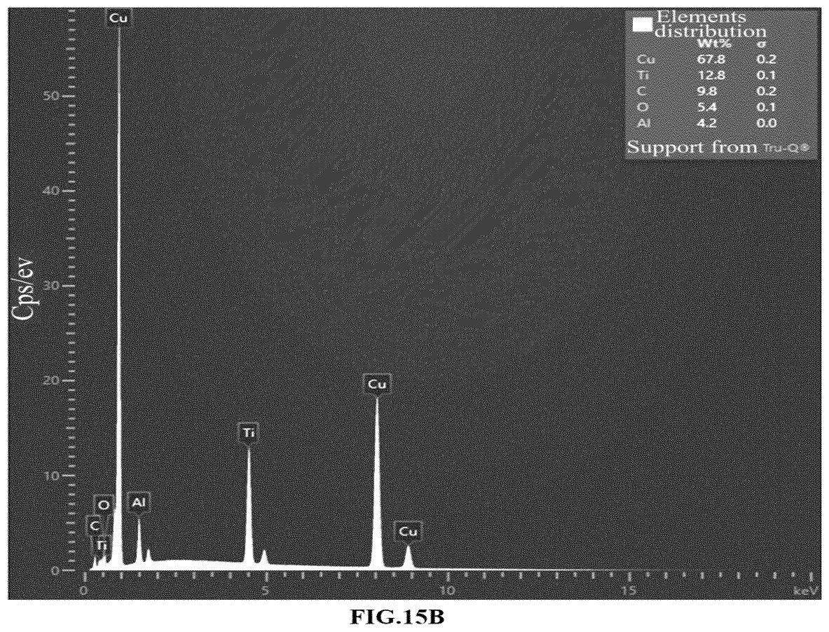

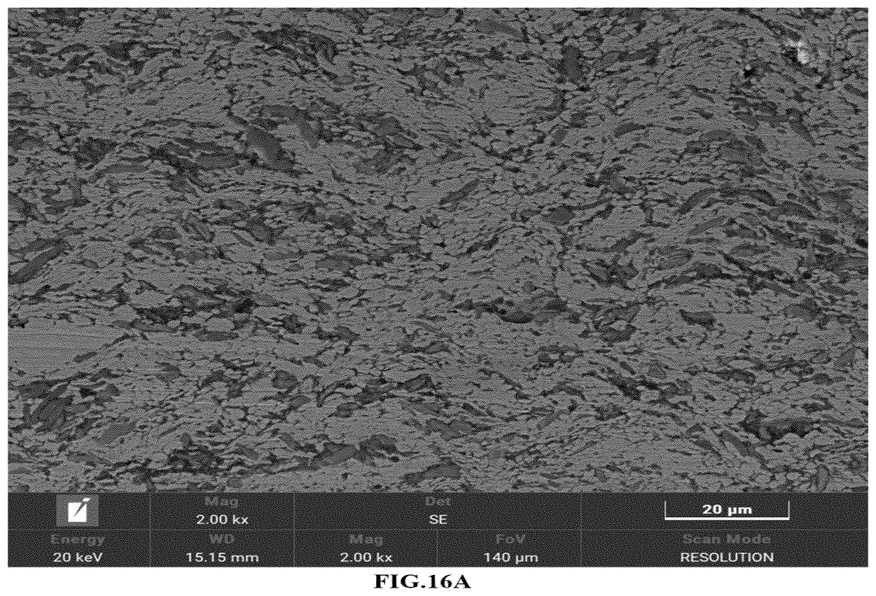

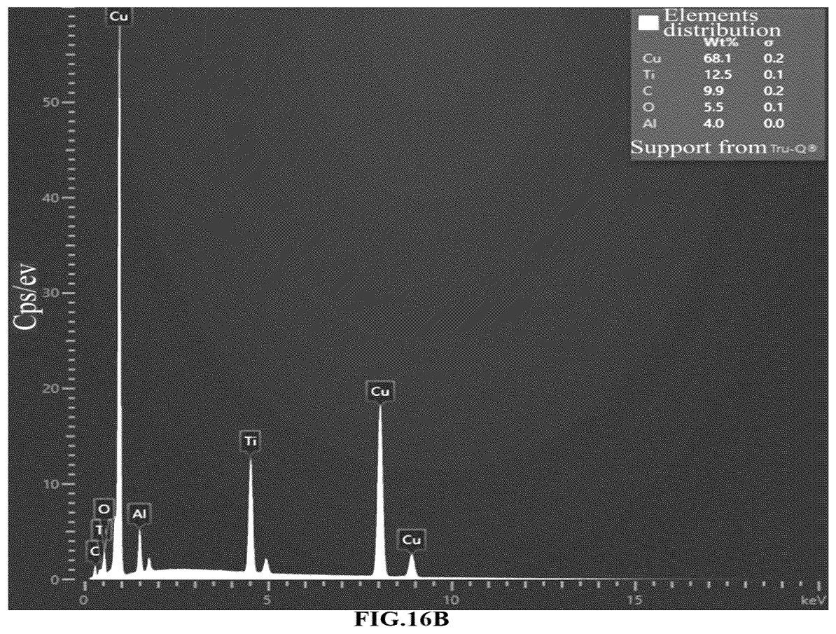

As can be seen from FIG. 14A, FIG. 14B, FIG. 15A, FIG. 15B, FIG. 16A and FIG. 16B, the composite coating has a dense structure, titanium-aluminum-carbon ceramic particles are evenly distributed in the coating, and copper particles are compacted and squeezed during the cold spraying to form a flat stack in the coating. In the images, the light gray structure is copper, the dark gray structure is titanium aluminum carbon, and the black structure is pores generated during the coating deposition. There are areas where titanium-silicon-carbon particles agglomerated in the coating. Due to the difference in particle structure between titanium-silicon-carbon and copper, the bonding interface between titanium-silicon-carbon and copper is prone to stress concentration, and there are generally defects such as pores and cracks around the contact area between copper and titanium-aluminum-carbon. There is also a certain number of pores inside the titanium-aluminum-carbon agglomerated particles, because the physical characteristics of the ceramic particles lead to weak bonding among the ceramic particles. The composite coating according to the present disclosure does not oxidize during spraying at different airflow temperatures.

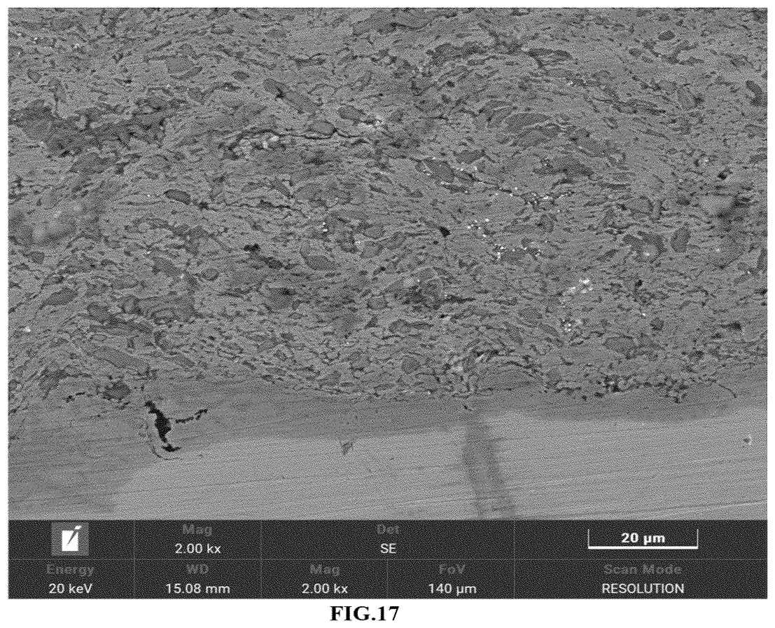

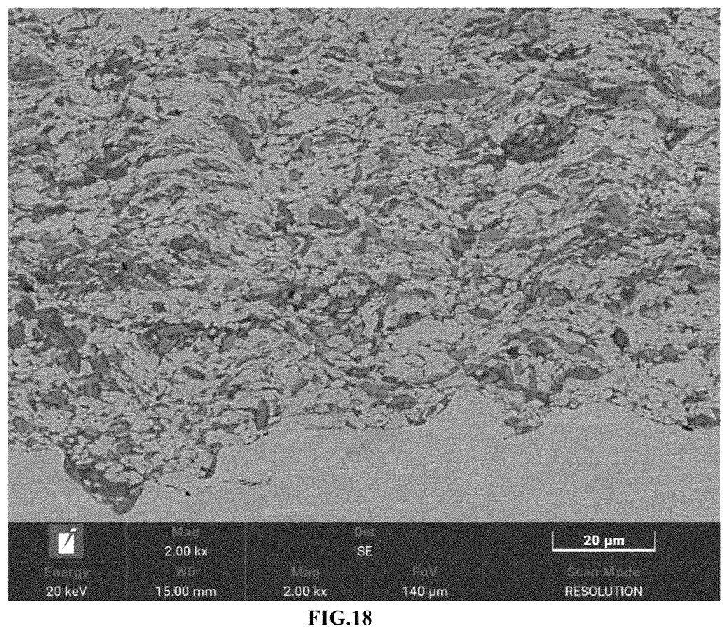

As can be seen from FIG. 17 to FIG. 19, the interface of the coating is well bonded, and as the spraying temperature increases, the released residual stress of the prepared coating increases accordingly. While at lower spraying temperatures, the impact velocity of copper particles is lower, and the degree of plastic deformation is lower during deposition and collision, so the hammering or tamping effect of copper particles is relatively poor. Therefore, the number of cracks in the coating is significantly reduced at higher spraying temperatures; the particle size of agglomerated ceramics gradually decreases with an increase of the spraying temperature, and the bonding surface between ceramics became denser. This is mainly because the impact velocity of the composite particles onto the surface of the substrate is high, such that the ceramic particles in the powder are violently collided and broken, and then bonded by the Cu particles with the agglomerated structure. Moreover, the subsequently deposited particles hit the surface at a high speed to further hammer and tamp the previously deposited particles, so as to achieve the compact bonding effect among these particles.

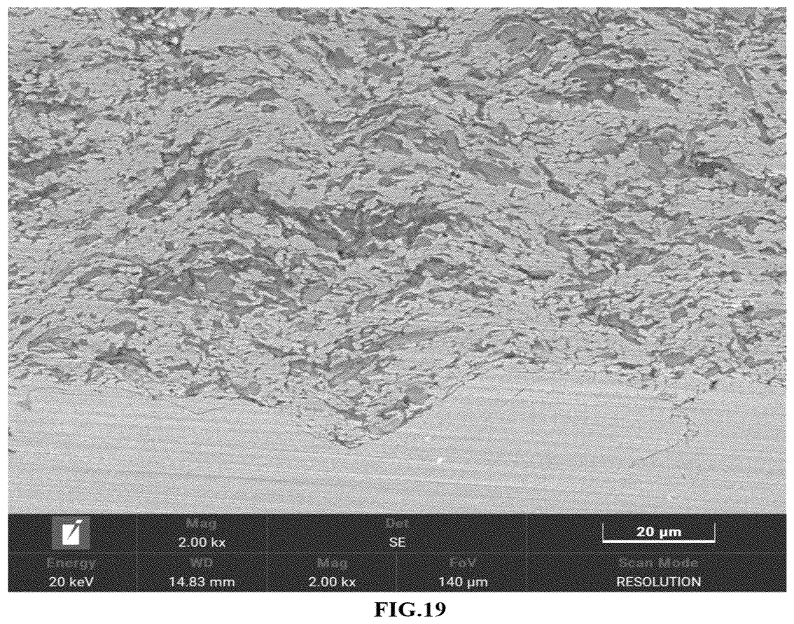

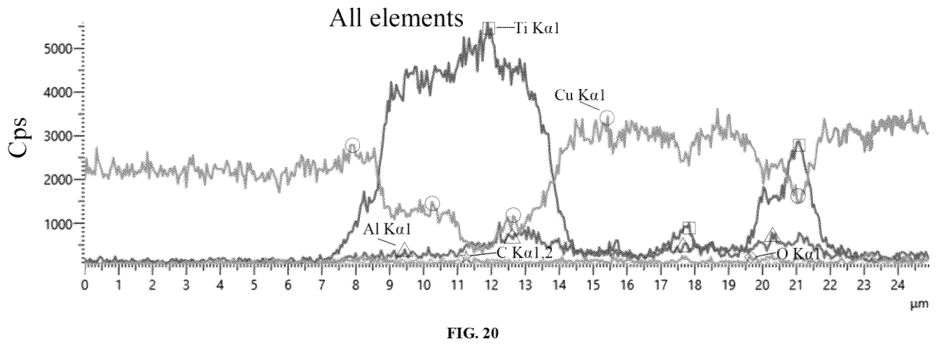

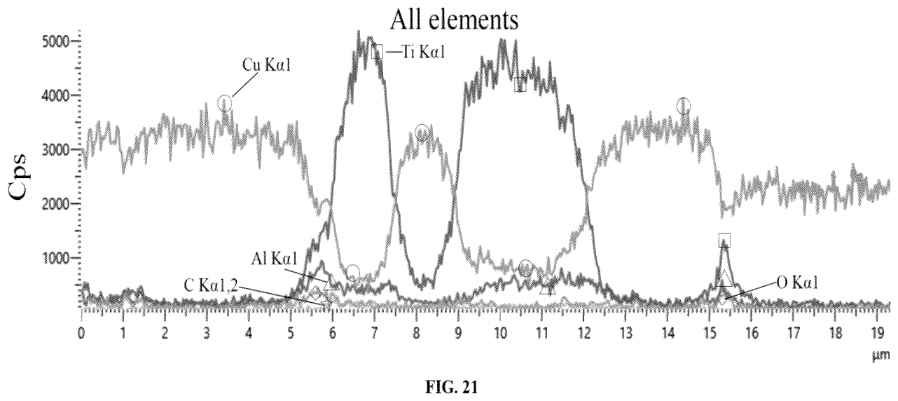

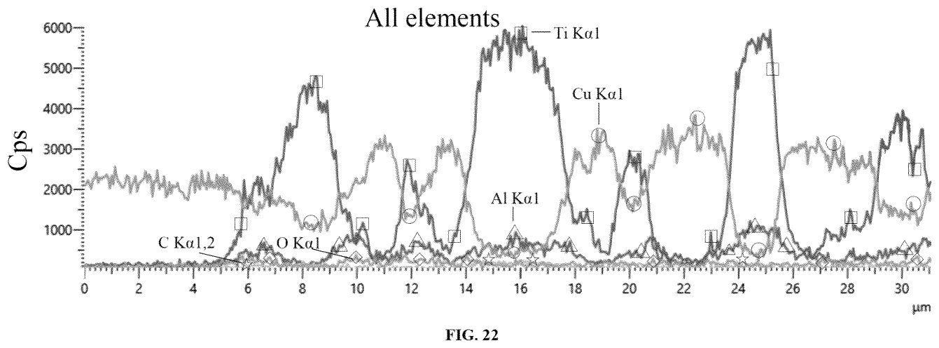

As can be seen from FIG. 20 to FIG. 22, as for the high-performance composite coating according to the present disclosure, from the coating to the boundary with substrate, the Cu element content drops suddenly near the boundary between the coating and the substrate, and then tends to be constant. This shows that there is substantially no diffusion of elements in the high-performance composite coating, proving that a bonding mechanism between the coating and the substrate is mechanical interlocking.

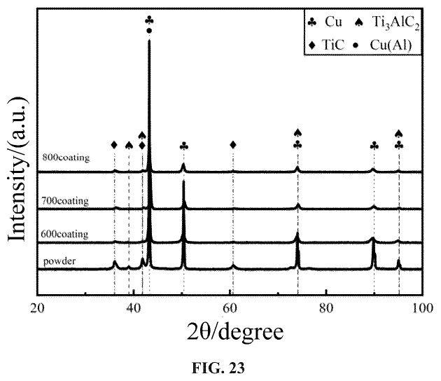

As can be seen from FIG. 23, the high-performance composite coating has phases that are composed of Cu, Ti₃AlC₂, Cu(Al), and TiC phases, and there is no obvious oxidation peak. This indicates that no phase change occurs and little oxidation occurs during the coating deposition.

In this experiment, the porosity of the high-performance composite coating is measured by using Image J software. Three different zones are selected from the SEM images of the cross-sections of each coating, and pixel values of the zones of pores and overall pixels of the images are calculated by adjusting the lightness and darkness of the pores. The porosity of the coating is roughly characterized by calculating the ratio. Table 1 shows the test data of the ceramic contents, the element distribution contents of the ceramic phase in the coatings, and the porosity in the high-performance composite coatings prepared in Examples 1 to 3.

TABLE 1
Ceramic content, ceramic phase content measured
by EDS, and porosity in high-performance composite
coatings prepared in Examples 1 to 3

| Example No. | Ceramic phase content/% | EDS/% | Porosity/% |
|---|---|---|---|
| Example 1 | 29.04 | 29.60 | 0.76 |
| Example 2 | 31.67 | 32.20 | 0.64 |
| Example 3 | 31.12 | 31.90 | 0.58 |

As can be seen from Table 1, the average values of the porosity of the high-performance composite coatings prepared in Examples 1 to 3 are 0.76%, 0.64%, and 0.58%, respectively. The pores of the high-performance composite coating decreases with an increase of the spraying temperature, because the increase of the spraying temperature increases an impact velocity of the agglomerated particles, and plastic deformation of the copper particles is larger, and the bonding interface among the particles is denser. The average values of ceramic contents of the high-performance composite coatings prepared in Examples 1 to 3 are 29.04%, 31.67%, and 31.12%, respectively. In FIG. 14 to FIG. 16, the EDS element distribution-based ceramic contents of the high-performance composite coatings in Examples 1 to 3 are about 29.60%, 32.20% and 31.90%, respectively, which are not much different from the results calculated by Image J software in Examples 1 to 3, indicating that the calculation results of the ceramic contents are within an allowable error range. By comparing the results of the three kinds of ceramic contents, it is found that the coating ceramic content does not increase significantly due to the further increase of the spraying temperature at a higher spraying temperature. This is mainly because of a cohesive force of the composite agglomerated powder, such that the impact and rebound physical effects of the ceramic reinforcement phase do not change significantly due to the change of temperature.

The macro-morphology of a fracture surface on the substrate side after a bonding strength test and the macro-morphology of a fracture surface on the coating side after a bonding strength test show that, the high-performance composite coating is basically detached from the surface of the substrate as a whole, and only a small part of the edge of the coating remains on the surface of the substrate. This might be due to the doping of Ti₃AlC₂ particles in the coating, resulting in interface defects among the particles in the coating, which make the cohesion between the coatings less than the bonding force between the coating and the substrate. Alternatively, the heights of the middle and edge parts of the substrate surface are inconsistent, such that there are defects between the substrate and the coating when the coating is prepared. After being drawn, the coating has a flat fracture surface, and there is no shrinkage and tearing morphology macroscopically, which is consistent with the characteristics of brittle fracture. This macroscopic fracture morphology is a typical feature of mechanical interlocking bonding of the high-performance composite coatings.

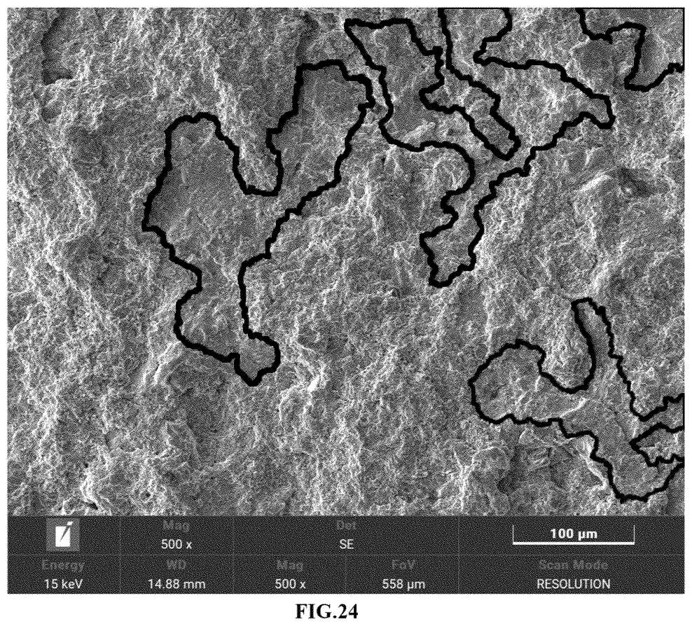

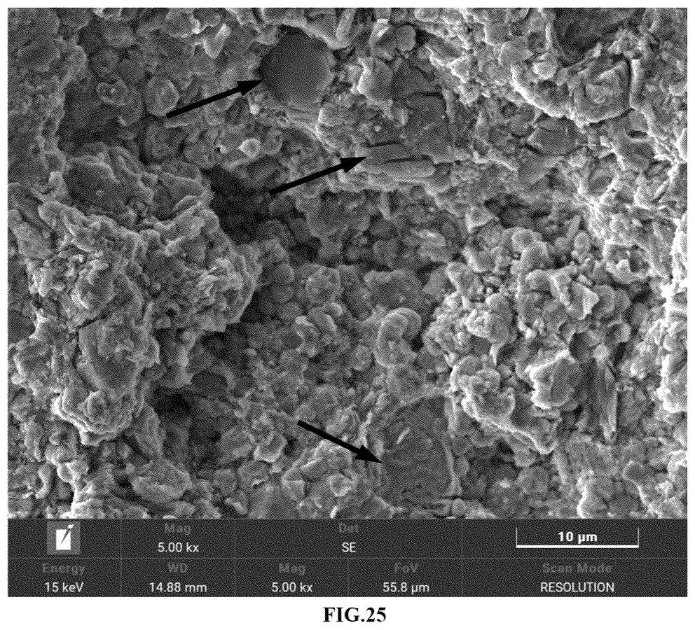

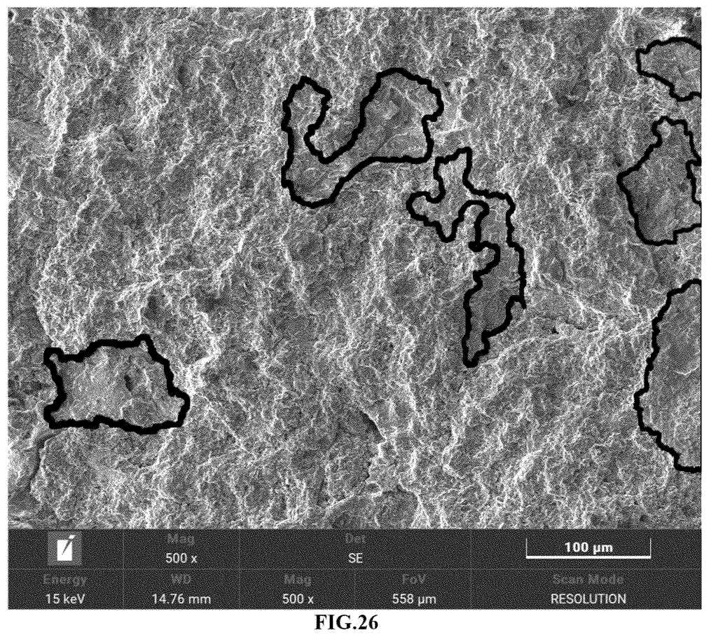

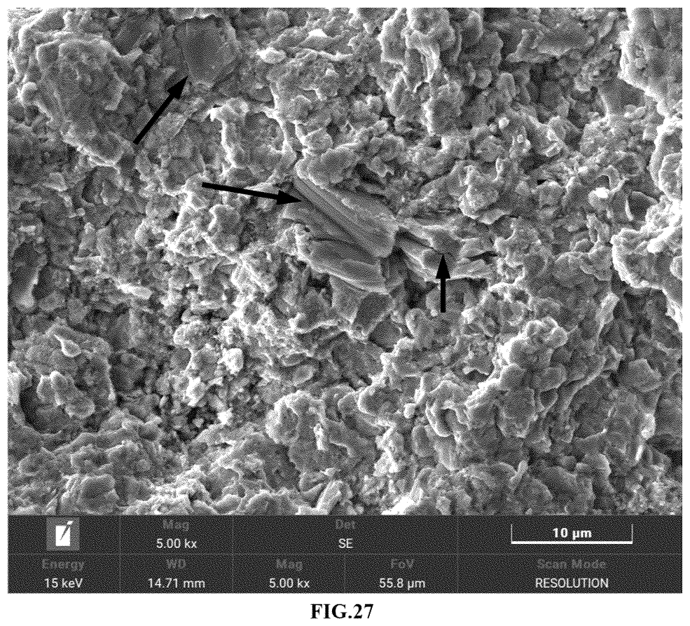

As can be seen from FIG. 24 to FIG. 27, the fracture surface on the substrate side is relatively flat and smooth, and there is a few coating residues on the substrate side when the coating as a whole is separated from the substrate side. In FIG. 24, the black area is a surface of the brass substrate, showing that the bonding force between the coating and the substrate is not much different from the cohesion of the coating. As can be seen from FIG. 25, there are relatively complete ceramic reinforcement phases and ceramic shedding pits on the fracture surface, indicating that the bonding force between Cu and Ti₃AlC₂ particles is smaller than that between Cu particles. As can be seen from FIG. 27, the Ti₃AlC₂ reinforcement phase has a “cleavage step” at the fracture of the coating in Example 3 on the substrate side, indicating that the Ti₃AlC₂ particles are firmly bonded to the Cu-based coating. This might be related to the element diffusion between Cu and Ti₃AlC₂ particles. The spray powder has a relatively high content of Ti₃AlC₂ reinforcement phases, and brittle collisions are prone to occur during the particle deposition. As a result, there are more broken Ti₃AlC₂ particles at the fracture site, leading to a relatively small internal bonding force of the coating.

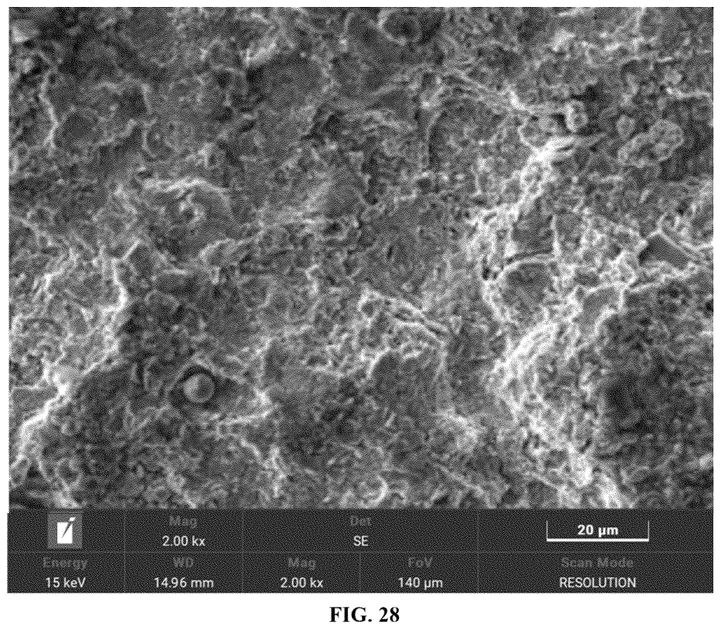

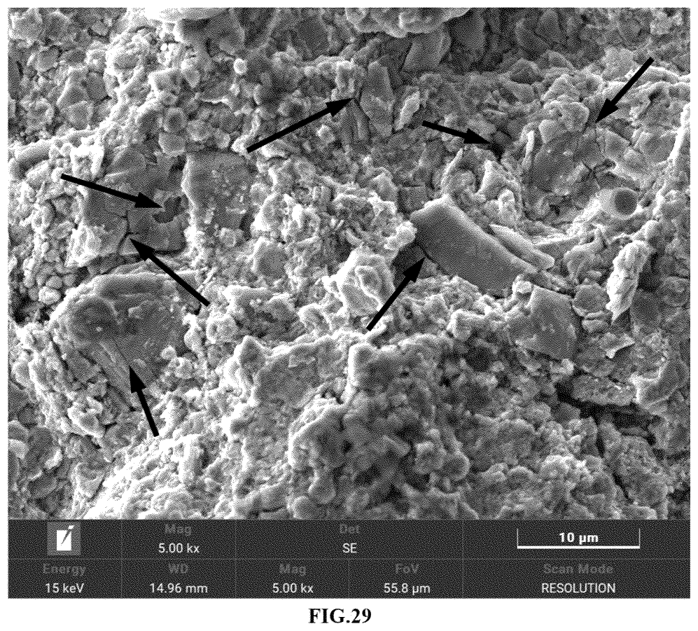

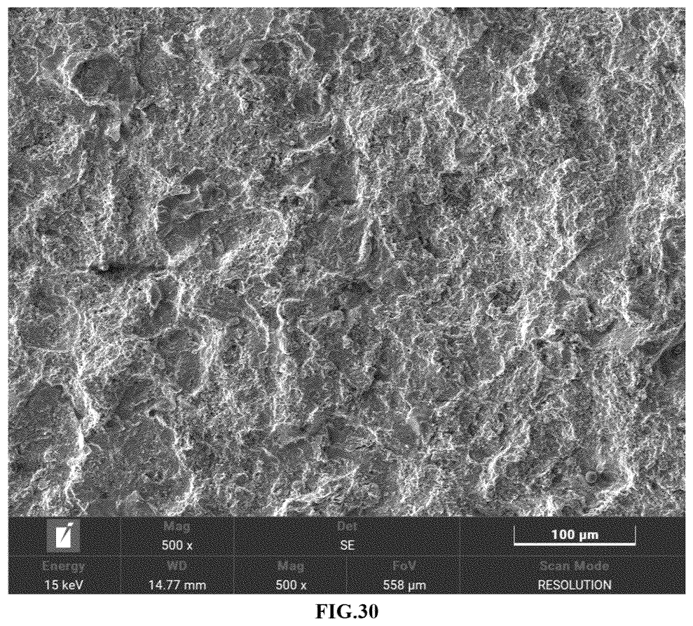

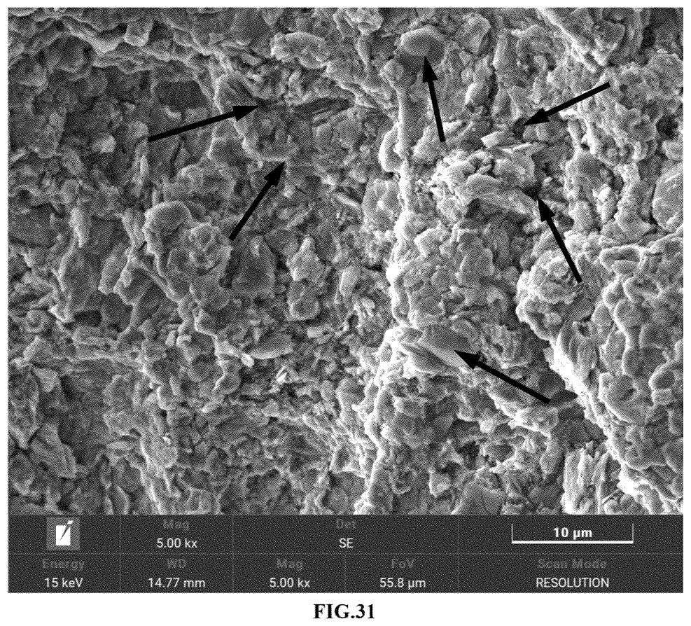

From FIG. 28 to FIG. 31, it can be seen that composite coatings with higher ceramic content might produce some unavoidable defects. From FIG. 29, it is clearly seen from the region indicated by the black arrow that there are obvious gaps and broken pits among the Ti₃AlC₂ particles on the fracture surface. This is mainly because the hard ceramic particles in the agglomerated composite powder collides with each other during the coating deposition, and the particles are trapped in the coating by the Cu particles in the agglomerated structure before rebounding, resulting in a lower internal bonding force of the high-performance composite coating prepared in Example 2. From the region indicated by the black arrow in FIG. 31, it can be seen that the ceramic particles are closely bonded to the copper-based coating, there are many small-sized ceramic particles in the coating, and there is no obvious gap between the ceramic particles. This is mainly due to the high impact velocity of the composite particles on the surface of the substrate, and the ceramic particles in the powder violently collides and breaks, and then are bonded by Cu particles in an agglomerated structure. The subsequently deposited particles hit the surface at high speed to further tamp the previously deposited particles, so as to achieve the tight bonding among particles.

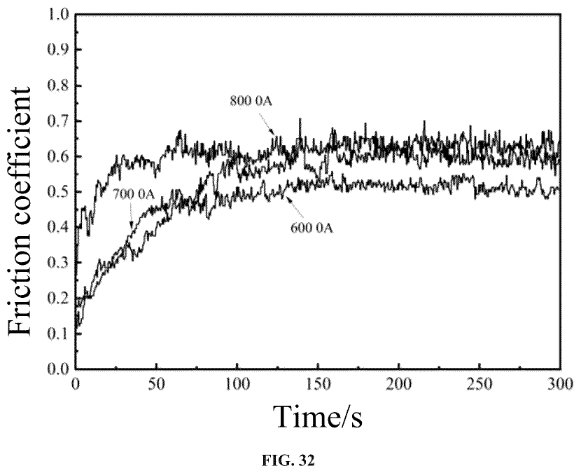

As can be seen from FIG. 32, the high-performance composite coating prepared in Example 1 has the lowest friction coefficient of 0.506, resulting in the best friction reduction performance; the high-performance composite coating prepared in Example 2 has a friction coefficient of 0.571; due to the densest internal structure, the high-performance composite coating prepared in Example 3 has a friction coefficient of 0.606, which is the maximum among the three examples, resulting in the worst friction reduction performance.

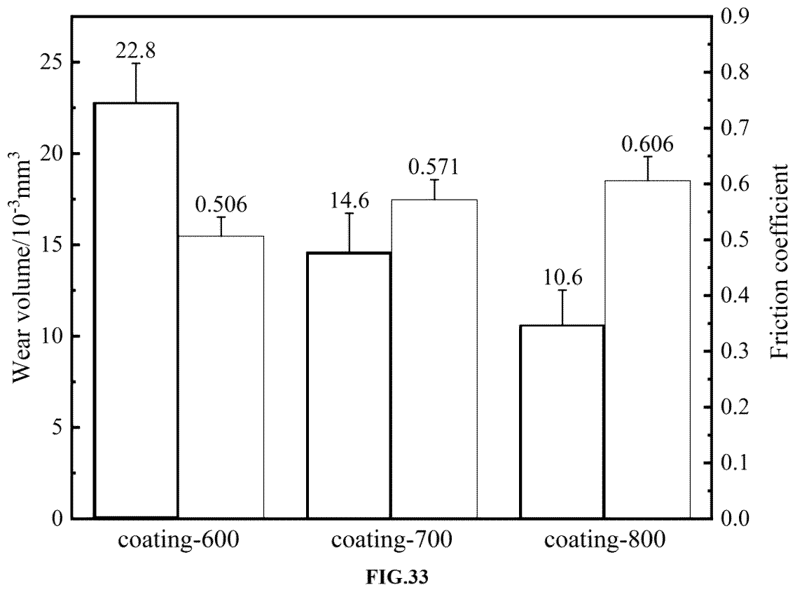

As can be seen from FIG. 33, the volume wear of the high-performance composite coatings prepared in Examples 1 to 3 are 22.8×10−3 mm³, 14.6×10−3 mm³, and 10.6×10−3 mm³, respectively; as the spraying temperature increases, the wear volume shows a decreasing trend. This is similar to the law of the bonding strength of the coating changing with temperature, indicating that a better bonding strength plays a greater role in resisting the wear of the coating caused by adhesion and peeling of titanium-aluminum-carbon during the friction. There is an inverse relation between the friction coefficient and the volume wear, indicating that the material with good friction reduction performance during the friction might not certainly have excellent wear resistance. This further confirms that the combination of metal copper with ceramics as a composite wear-resistant material is one of the preferred methods for exploring comprehensive anti-friction and wear-resistant materials.

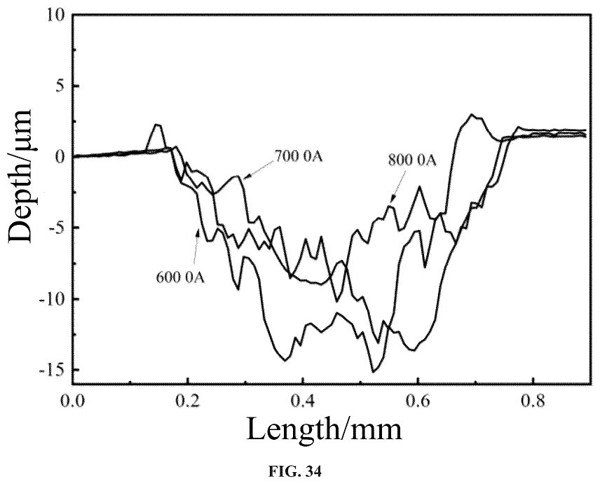

As can be seen from FIG. 34, the high-performance composite coating prepared in Example 1 has the largest wear scar depth, reaching 15.14 μm; the high-performance composite coating prepared in Example 3 has the lowest wear scar depth, which is only 10.17 μm; and the high-performance composite coating prepared in Example 2 has a wear scar depth between the above two, which is 12.10 μm. This shows that the wear scar depths of Examples 1 to 3 are consistent with the change trend of the volume wear.

Table 2 shows the EDS data statistics of wear scars in the high-performance composite coatings prepared in Examples 1 to 3.

TABLE 2
EDS data statistics of wear scars in the high-performance
composite coatings prepared in Examples 1 to 3

| | Element/Atom % | | | | | |
|---|---|---|---|---|---|---|
| Example No. | Cu | Fe | Ti | Al | C | O |
| Example 1 | 31.86 | 7.04 | 5.36 | 3.08 | 13.72 | 38.93 |
| Example 2 | 21.56 | 16.76 | 4.76 | 2.22 | 11.62 | 43.08 |
| Example 3 | 27.17 | 12.72 | 5.53 | 2.51 | 12.75 | 39.32 |

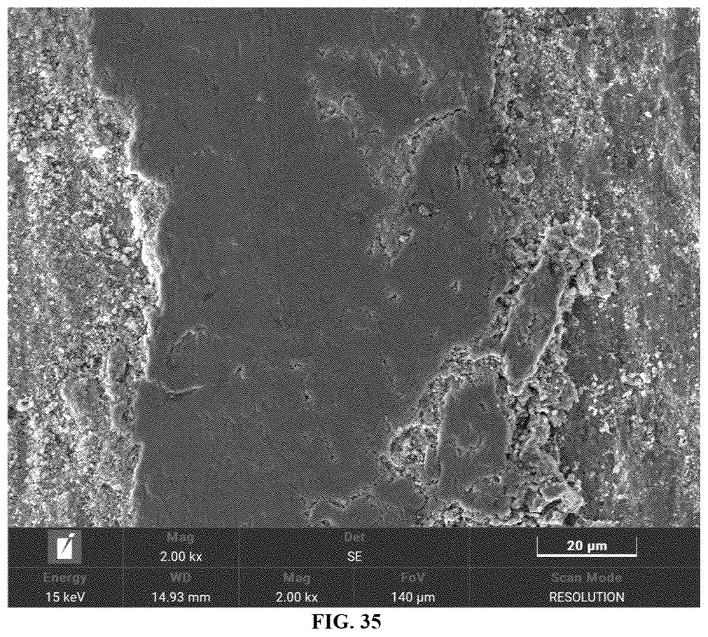

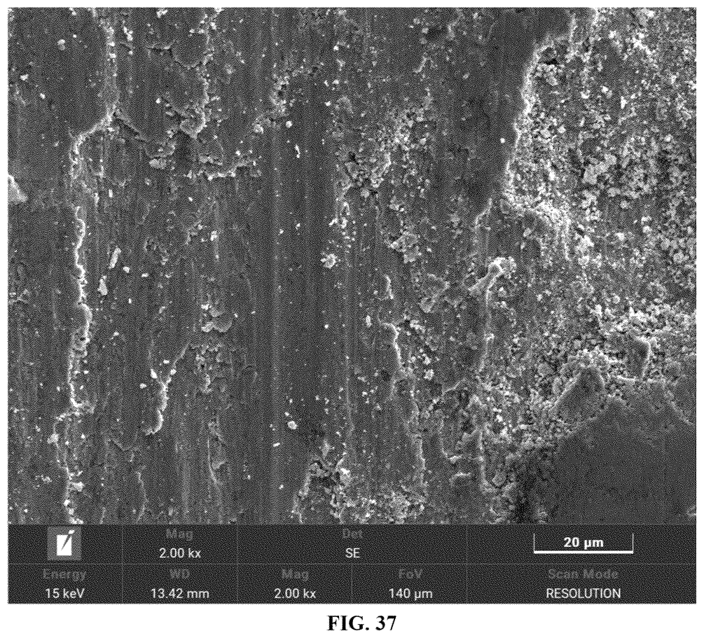

As can be seen from FIG. 35 to FIG. 37, as the spraying temperature increases, the number of furrows on the wear scar surface of the coating decreases and the furrows become shallower.

The high-performance composite coating prepared in Example 1 has the most severe coating wear, with serious furrowing and delamination in the wear scars, and more wear debris on the surface of the wear scars (FIG. 35). Due to the high ceramic content in the coating, the bonding among particles is not dense enough, and the coating has a relatively “loose” structure, resulting in a large number of titanium-silicon-carbon particles falling out of the coating during the friction, intensifying the wear of the coating. As can be seen from Table 2, the content of Cu and O elements in the wear scars of Example 1 is relatively high, so it can be inferred that a relatively obvious oxidation reaction occurs on the surface of the coating, and the hard particles composed of ceramic compounds and oxides in the grinding debris might cause obvious grooves on the surface of the wear scar during the reciprocating friction. Since a large number of oxides formed on the surface of the coating plays a certain role in reducing friction, the high-performance composite coating prepared in Example 1 shows a lower friction coefficient. During the dry friction, a wear mechanism of the high-performance composite coating prepared in Example 1 includes abrasive wear, oxidative wear, and slight adhesive wear.

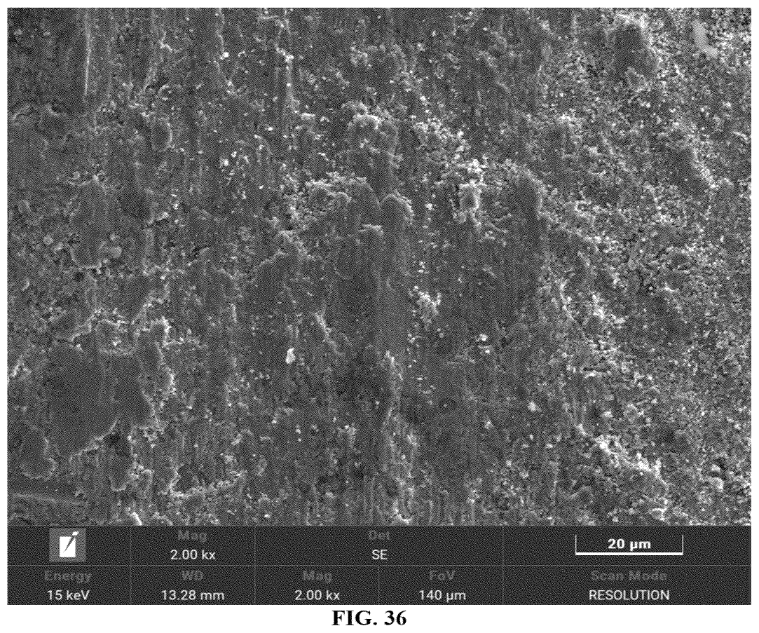

As for the high-performance composite coating prepared in Example 2, obvious delamination and shallow furrows appears in the wear scars of the coating. In conjunction with the scanning results of the coating in Example 2 shown in Table 2, it is found that Fe and O elements account for 59.84% of the surface components of the wear scars, and the steel balls are more worn. Compared with the other two coatings, the wear scar surface of the coating of this example is relatively flat (FIG. 36). Since the high-performance composite coating has a higher cohesive strength (greater than 38.1 MPa), the delamination caused by adhesive wear is not serious, resulting in a low wear volume. During the dry friction, a wear mechanism of the high-performance composite coating prepared in Example 2 includes adhesive wear, oxidative wear, and slight abrasive wear.

As for the high-performance composite coating prepared in Example 3, severe exfoliation appears on the wear scar surface of the coating. During the friction, the soft copper material in the coating is consumed, and the hard Ti₃AlC₂ particles become convex peaks on the friction contact surface, resulting in a relatively high friction coefficient of the coating. Since the high-performance composite coating prepared in Example 3 has a desirable forming quality and a compact coating structure, Ti₃AlC₂ ceramic particles are embedded tightly in the coating and are not easy to be pull out under external force, such that the exposed Ti₃AlC₂ ceramic particles on the surface of the wear scar are tightly pinned to the wear scars, which is not easy to cause wear on the coating surface. It can be seen from Table 2 that, the surface of the wear scar in Example 3 contains relatively high level of O and Fe elements and remaining elements from the coating composition, implying that oxidation reactions occurs during the friction. Meanwhile, due to the high hardness (397 HV_{0.5}) of the coating, the width of the wear scar is lower, which imparts better wear resistance to the coating. During the dry friction, a wear mechanism of the high-performance composite coating prepared in Example 3 includes adhesive wear, oxidative wear, and slight abrasive wear.

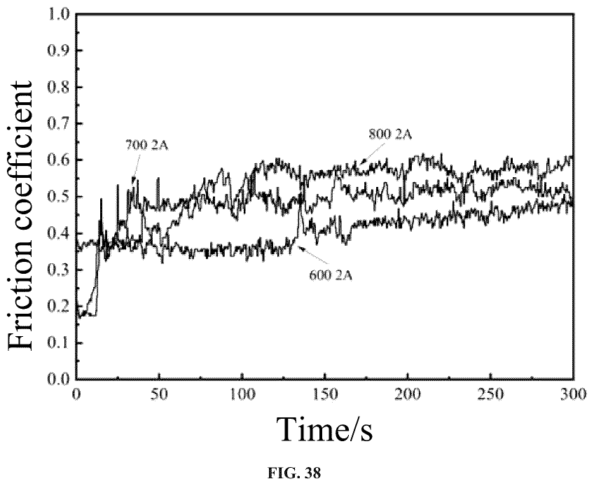

As can be seen from FIG. 38, compared with the dry friction state, the friction coefficient of the Cu—Ti₃AlC₂ composite coating under the current-carrying friction decreases overall, showing a relatively stable friction reduction performance. In the current-carrying state, due to the sharp rise of the local temperature of the friction pair, the material softens, the hindrance between the convex peaks decreases, and the shear strength decreases, resulting in a decrease in the friction coefficient. The high-performance composite coating prepared in Example 1 has the lowest friction coefficient of 0.487. The high-performance composite coating prepared in Example 2 has a friction coefficient of 0.507, which is between the other two. The high-performance composite coating prepared in Example 3 has the highest friction coefficient of 0.548.

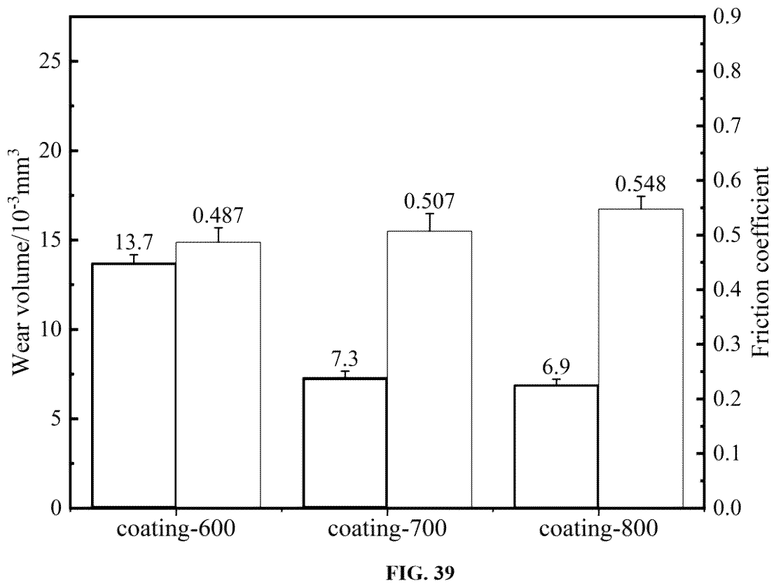

As can be seen from FIG. 39, the high-performance composite coatings prepared in Examples 1 to 3 has volume wear values of 13.7×10⁻³ mm³, 7.3×10⁻³ mm³, and 6.9×10⁻³ mm³ under 2 A current-carrying friction, respectively. The experimental data of wear shows that the high-performance composite coatings prepared in Example 2 and Example 3 has desirable friction reduction properties under current-carrying friction. As the spraying temperature increases, the wear volume shows a decreasing trend but the friction coefficient shows an increasing trend.

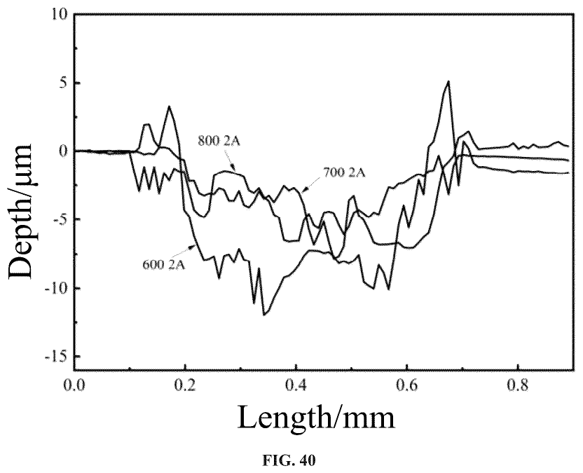

As can be seen from FIG. 40, the high-performance composite coating prepared in Example 1 has the largest wear scar depth, reaching 11.64 μm; the high-performance composite coating prepared in Example 3 has the lowest wear scar depth, which is only 6.59 μm; and the high-performance composite coating prepared in Example 2 has a wear scar depth between the above two, which is 7.83 μm. This shows that the high-performance composite coatings prepared at a higher spraying temperatures has a lower wear scar depth and lower volume wear.

Table 3 shows the wear scar EDS data statistics of the high-performance composite coatings prepared in Examples 1 to 3 under 2 A current-carrying friction.

TABLE 3
Wear scar EDS data statistics of high-
performance composite coatings prepared in
Examples 1 to 3 under 2A current-carrying friction

| | Element/Atom % | | | | | |
|---|---|---|---|---|---|---|
| Example | Cu | Fe | Ti | Al | C | O |
| Example 1 | 36.20 | 9.08 | 5.77 | 3.43 | 15.08 | 30.45 |
| Example 2 | 29.39 | 11.19 | 5.80 | 2.85 | 15.09 | 35.69 |
| Example 3 | 32.87 | 10.19 | 5.60 | 3.07 | 12.69 | 35.58 |

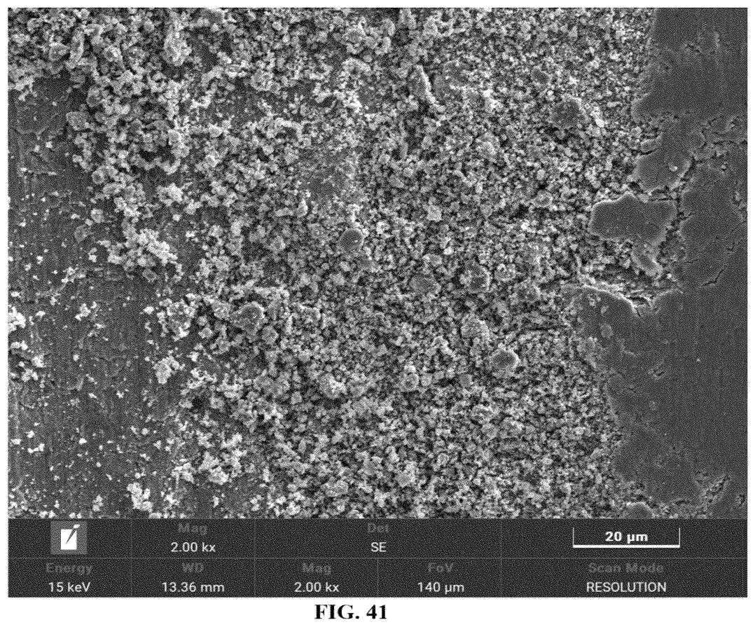

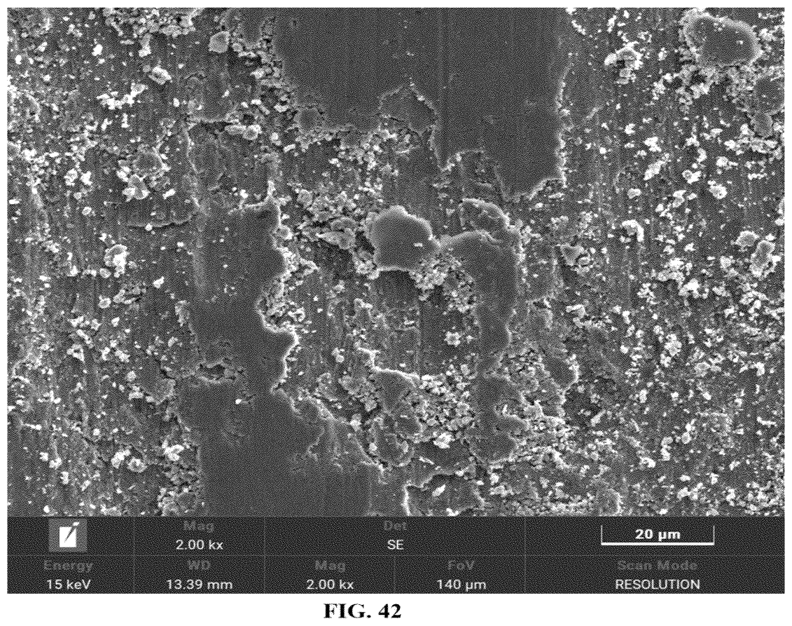

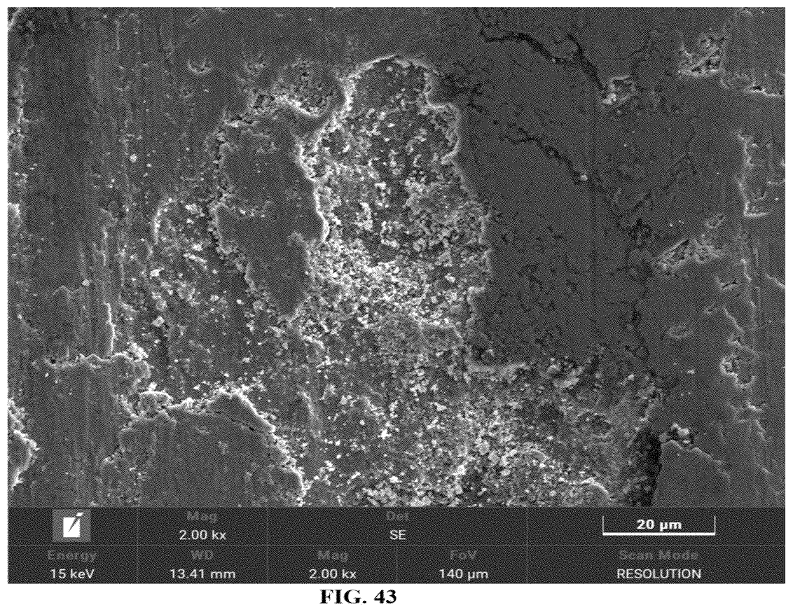

As can be seen from FIG. 41 to FIG. 43, the increase of spraying temperature leads to less delamination of the coating.

As for the wear scar morphology of the high-performance composite coating prepared in Example 1 under 2 A current-carrying friction, compared with dry friction, there is no furrow on the surface of the coating wear scar, but more and larger wear debris are scattered. As can be seen from Table 3, the wear scar composition of Example 1 has relatively low content of Fe and O, and it can be inferred that there are more abrasive particles on the grinding surface to protect the coating surface. During the 2 A current-carrying friction, the high-performance composite coating prepared in Example 1 has a wear mechanism of abrasive wear, adhesive wear, and oxidative wear.

The high-performance composite coating prepared in Example 2 has desirable plastic deformation resistance and high hardness under 2 A current-carrying friction. After softening, the adhesive wear causes the coating to fall off in a large area to a lesser extent. Under current-carrying friction, the high-performance composite coating prepared in Example 2 has a relatively-flat wear scar surface, and the impact of arc ablation is relatively small; under the action of friction heat, Joule heat, and arc heat, only a small number of wear debris exists on the coating surface. As can be seen from Table 3, the contents of Fe and O in the wear scar components of Example 2 are higher, and the contact between the composite coating and the friction surface of the grinding ball is more sufficient. This could indicate that the high-performance composite coating prepared in Example 2 has better wear resistance than that of the high-performance composite coating prepared in Example 1. During the 2 A current-carrying friction, the high-performance composite coating prepared in Example 2 has a wear mechanism of adhesive wear, oxidative wear, and slight abrasive wear.

The high-performance composite coating prepared in Example 3 has the best plastic deformation resistance, the highest hardness, the least delamination of the composite coating, the flattest wear scar surface, and the least surface wear debris under 2 A current-carrying friction. As shown in Table 3, the Fe and O contents of wear scars in the high-performance composite coating prepared in Example 3 are not much different from those of Example 2, indicating that the wear resistance of the high-performance composite coating prepared in Example 3 is almost the same as that of the high-performance composite coating prepared in Example 2. During the 2 A current-carrying friction, the high-performance composite coating prepared in Example 3 has a wear mechanism of adhesive wear, oxidative wear, and slight abrasive wear.

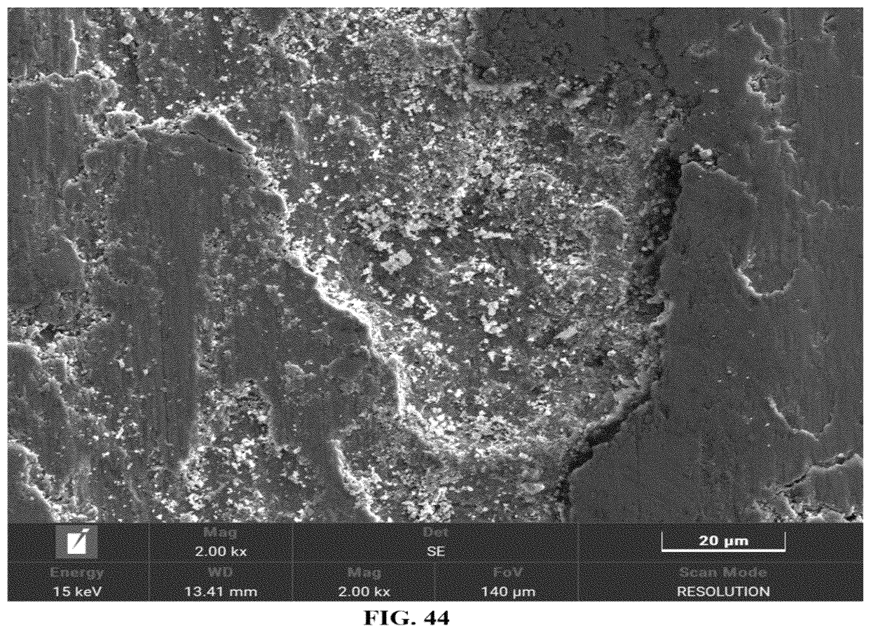

As can be seen from FIG. 44, no serious ablation is found on the surface of the coating, only white particles gathered in many places (mainly composed of copper and copper oxide). It could be understood that a high titanium-aluminum-carbon content is conducive to the formation of a “third-phase” friction layer, protecting the coating to reduce the impact of arc ablation. A particle size of the particles located below the stack layer reaches nanometer level. In addition, the accumulation and filling of a large number of nano-scale particles is also found in the cracks, spalling pits, step edges and other defects of the coating. The wear of the coating is thereby improved.

As can be seen from FIG. 41 to FIG. 43, more nano-scale particles are found in the wear scar regions of the high-performance composite coatings prepared in Examples 1 and 2, while less are found in the high-performance composite coating prepared in Example 3. Comparing the structure of the three coatings and friction conditions used, it can be seen that the aggregation of nano-sized particles is more obvious in the composite coating with a higher spraying temperature, indicating that the addition of titanium-aluminum-carbon could enhance the formation of nano-sized particles in the coating. On one hand, the coating with high titanium-aluminum-carbon content involves insufficient surface contact during friction, which promotes the generation of arcs, and promotes the softening and transfer of the friction pair materials. On the other hand, in the electric coupling environment, the shedding part of the friction pair material is softened by heat, and is more likely to transfer and break. Further, the titanium-aluminum-carbon particles in the friction interface grinds the falling particles to generate nano-scale particles with a smaller particle size. These particles are transferred to the coating defects during the friction to achieve the structural filling and “self-healing” of the coating.

TABLE 4
Performances of high-performance
composite coatings prepared in Examples 1 to 3

| | | | | | Volume | Wear |
|---|---|---|---|---|---|---|
| | Hard- | Bonding | | Friction | wear/ | scar |
| Example | ness/ | strength/ | Friction | Coef- | 10⁻³ | depth/ |
| No. | HV | MPa | conditions | ficient | mm³ | μm |
| Example | 231.5 | 10 | Dry friction | 0.506 | 22.8 | 15.14 |
| 1 | | | 2A | 0.487 | 13.7 | 11.64 |
| | | | Current- | | | |
| | | | carrying | | | |
| | | | friction | | | |
| Example | 273.8 | 38 | Dry friction | 0.571 | 14.6 | 12.10 |
| 2 | | | 2A | 0.507 | 7.3 | 7.83 |
| | | | current- | | | |
| | | | carrying | | | |
| | | | friction | | | |
| Example | 397.1 | 50 | Dry friction | 0.606 | 10.6 | 10.17 |
| 3 | | | 2A | 0.548 | 6.9 | 6.59 |
| | | | Current- | | | |
| | | | carrying | | | |
| | | | friction | | | |

The above descriptions are merely preferred embodiments of the present disclosure. It should be noted that a person of ordinary skill in the art may further make several improvements and modifications without departing from the principle of the present disclosure, and such improvements and modifications should be deemed as falling within the protection scope of the present disclosure.

1. A method for preparing a composite coating, comprising steps of
(1) ball milling a Cu powder, a Ti₃AlC₂ powder, an organic adhesive, a dispersant, and water to obtain a mixed slurry;
(2) subjecting the mixed slurry obtained in step (1) to spray granulation to obtain granules, and sintering the granules, to obtain a composite powder; and
(3) spraying the composite powder obtained in step (2) onto a substrate material to obtain the composite coating,
wherein in step (1), the organic adhesive is one or more selected from the group consisting of asphalt, resin, rubber, gum arabic, and polyvinyl alcohol;
in step (1), the organic adhesive is in an amount of 1% to 3% of a total mass of the Cu powder and the Ti₃AlC₂ powder;
in step (1), a volume ratio of the Cu powder to the Ti₃AlC₂ powder is in a range of (55-65):(35-45); and
in step (2), the sintering is conducted at a temperature of 500° C. to 950° C. for 1 h to 4 h.

2. (canceled)

3. The method as claimed in claim 1, wherein in step (1), the Cu powder and the Ti₃AlC₂ powder each independently have a particle size of 2 μm to 8 μm.

4. (canceled)

5. The method as claimed in claim 1, wherein in step (1), the dispersant is in an amount of 0.2% to 0.8% of a total mass of the Cu powder and the Ti₃AlC₂ powder.

6. (canceled)

7. The method as claimed in claim 1, wherein in step (2), the composite powder has a particle size of 15 μm to 45 μm.

8. (canceled)

9. A composite coating, which is prepared by a method comprising steps of
(1) ball milling a Cu powder, a Ti₃AlC₂ powder, an organic adhesive, a dispersant, and water to obtain a mixed slurry;
(2) subjecting the mixed slurry obtained in step (1) to spray granulation to obtain granules, and sintering the granules, to obtain a composite powder; and
(3) spraying the composite powder obtained in step (2) onto a substrate material to obtain the composite coating,
wherein in step (1), the organic adhesive is one or more selected from the group consisting of asphalt, resin, rubber, gum arabic, and polyvinyl alcohol;
in step (1), the organic adhesive is in an amount of 1% to 3% of a total mass of the Cu powder and the Ti₃AlC₂ powder;
in step (1), a volume ratio of the Cu powder to the Ti₃AlC₂ powder is in a range of (55-65):(35-45); and
in step (2), the sintering is conducted at a temperature of 500° C. to 950° C. for 1 h to 4 h.

10. A method for preparing a conductive slip ring for precision equipment by using the composite coating as claimed in claim 9.

11. (canceled)

12. The composite coating as claimed in claim 9, wherein in step (1), the Cu powder and the Ti₃AlC₂ powder each independently have a particle size of 2 μm to 8 μm.

13. (canceled)

14. The composite coating as claimed in claim 9, wherein in step (1), the dispersant is in an amount of 0.2% to 0.8% of a total mass of the Cu powder and the Ti₃AlC₂ powder.

15. (canceled)

16. The composite coating as claimed in claim 9, wherein in step (2), the composite powder has a particle size of 15 μm to 45 μm.

17-18. (canceled)

19. The method as claimed in claim 1, wherein the composite coating has a thickness of 700 μm to 800 μm.

20. (canceled)
